(19) United States
(12) Patent Application Publication
(10) Pub. No.: US 2026/0154032 A1
(43) Pub. Date: Jun. 4, 2026

(54) METHOD AND SYSTEM OF OFFLOADING AUDIO PROCESSING

(71) Applicant: QUALCOMM Incorporated, San Diego, CA (US)

(72) Inventors: Anuj DESHMUKH, Nagpur (IN); Brijesh Singh TIWARI, Bangalore (IN)

(21) Appl. No.: 18/964,942

(22) Filed: Dec. 2, 2024

(51) Int. Cl. G06F 3/16; H04R 1/10

(52) U.S. Cl. CPC G06F 3/162; H04R 1/1041; H04R 2420/07

(57) ABSTRACT

A device includes a memory configured to store processing configuration data that indicates one or more processing configurations. The device also includes one or more processors coupled to the memory. The one or more processors are configured to select, based on a power indicator, a processing configuration of the one or more processing configurations. The one or more processors are configured to, based on the selected processing configuration, send an indicator to a host device to offload one or more audio processing operations. The one or more processors are configured to, based on the selected processing configuration, configure the one or more processors to selectively bypass the one or more audio processing operations. The one or more processors are configured to, based on the selected processing configuration, send, to the host device, microphone audio data based on an audio input received by a microphone.

### FIELD

The present disclosure is generally related to offloading audio processing.

### DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process

executable instructions, including software applications, such as a web browser application, that can be used to access the Internet. As such, these devices can include significant computing capabilities.

As wearable electronic device technology has advanced, earbuds and other in-ear wearable devices have become popular for providing immersive audio experiences to users. These wearable electronic devices, such as earbuds or headsets, may be configured to establish a peer-to-peer (P2P) link with a host device to enable a wearable electronic device to provide an audio experience. The P2P link typically has data transfer rate constraints and latency constraints such that audio processing is performed at the wearable electronic device. For example, the wearable electronic device may be configured to perform clear voice communication (CVC) processing, such as echo cancellation and noise suppression (ECNS) processing, on an audio signal and provide a processed audio signal to the host device via the P2P link. However, performing the audio processing at the wearable electronic device can be power consumption intensive (e.g., consume a relatively large amount of battery power). As a result, performing the audio processing at the wearable electronic device increases a discharge rate of a battery of the wearable electronic device, decreases a usage time of the wearable electronic device before having to recharge the battery, and can negatively impact a user experience. III. Summary

According to one implementation of the present disclosure, a device includes a memory configured to store processing configuration data that indicates one or more processing configurations. The device also includes one or more processors coupled to the memory. The one or more processors are configured to select, based on a power indicator, a processing configuration of the one or more processing configurations. The one or more processors are configured to, based on the selected processing configuration: send an indicator to a host device to offload one or more audio processing operations, configure the one or more processors to selectively bypass the one or more audio processing operations, and send, to the host device, microphone audio data based on an audio input received by a microphone.

According to another implementation of the present disclosure, a method of operating a processor of an audio device. The method includes selecting, based on a power indicator, a processing configuration of one or more processing configurations. The method also includes, based on the selected processing configuration: sending an indicator to a host device to offload one or more audio processing operations, configuring the one or more processors to selectively bypass the one or more audio processing operations, and sending, to the host device, microphone audio data based on an audio input received by a microphone.

According to another implementation of the present disclosure, a non-transitory computer-readable medium storing instructions that are executable by one or more processors to cause the one or more processors to select, based on a power indicator, a processing configuration of one or more processing configurations. The instructions further cause the one or more processors to, based on the selected processing configuration: send an indicator to a host device to offload one or more audio processing operations, configure the one or more processors to selectively bypass the one or more audio processing operations, and send, to the host device, microphone audio data based on an audio input received by a microphone.

According to another implementation of the present disclosure, an apparatus includes means for selecting, based on a power indicator, a processing configuration of one or more processing configurations. The apparatus further includes means for sending, based on the selected processing configuration, an indicator to a host device to offload one or more audio processing operations. The apparatus further includes means for configuring, based on the selected processing configuration, the one or more processors to selectively bypass the one or more audio processing operations. The apparatus further includes means for sending, based on the selected processing configuration, microphone audio data to the host device. The microphone audio data is based on an audio input received by microphone.

According to another implementation of the present disclosure, a device includes a memory configured to store audio processing configuration data that indicates one or more audio processing configurations. The device also includes one or more processors coupled to the memory. The one or more processors are configured to receive, from an audio device, an indicator that indicates an audio processing configuration of the one or more audio processing configurations. The audio processing configuration is associated with one or more audio processing operations. The one or more processors are configured to, based on the indicator, configure the one or more processors to perform the one or more audio processing operations. The one or more processors are configured to receive, from the audio device, microphone audio data. The one or more processors are configured to perform, based on the microphone audio data, the one or more audio processing operations to generate an audio output.

According to another implementation of the present disclosure, a method includes receiving, from an audio device, an indicator that indicates an audio processing configuration of one or more audio processing configurations. The audio processing configuration is associated with one or more audio processing operations. The method also includes, based on the indicator, configuring one or more processors to perform the one or more audio processing operations. The method further includes receiving, from the audio device, microphone audio data. The method also includes performing, based on the microphone audio data, the one or more audio processing operations to generate an audio output.

According to another implementation of the present disclosure, a non-transitory computer-readable medium storing instructions that are executable by one or more processors to cause the one or more processors to receive, from an audio device, an indicator that indicates an audio processing configuration of one or more audio processing configurations. The audio processing configuration is associated with one or more audio processing operations. The instructions further cause the one or more processors to, based on the indicator, configure the one or more processors to perform the one or more audio processing operations. The instructions further cause the one or more processors to receive, from the audio device, microphone audio data. The instructions further cause the one or more processors to perform, based on the microphone audio data, the one or more audio processing operations to generate an audio output.

According to another implementation of the present disclosure, an apparatus includes means for receiving, from an audio device, an indicator that indicates an audio processing configuration of one or more audio processing configurations. The audio processing configuration is associated with one or more audio processing operations. The apparatus further includes means for configuring, based on the indicator, the apparatus to perform the one or more audio processing operations. The apparatus further includes means for receiving, from the audio device, microphone audio data. The apparatus further includes means for performing, based on the microphone audio data, the one or more audio processing operations to generate an audio output.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of an example of a system that supports offloading audio processing, in accordance with one or more aspects of the present disclosure.

FIG. 2 is a ladder diagram of an example of operation of a system that supports offloading audio processing, in accordance with one or more aspects of the present disclosure.

FIG. 3 is a diagram of an example of an integrated circuit operable to support offloading audio processing, in accordance with some examples of the present disclosure.

FIG. 4 is a diagram of a mobile device operable to support offloading audio processing, in accordance with some examples of the present disclosure.

FIG. 5 is a diagram of a headset operable to offload audio processing, in accordance with some examples of the present disclosure.

FIG. 6 is a diagram of a wearable electronic device operable to offload audio processing, in accordance with some examples of the present disclosure.

FIG. 7 is a diagram of a voice-controlled speaker system operable to support offloading audio processing, in accordance with some examples of the present disclosure.

FIG. 8 is a diagram of a headset, such as a virtual reality, mixed reality, or augmented reality headset, operable to offload audio processing, in accordance with some examples of the present disclosure.

FIG. 9 is a diagram of a mixed reality or augmented reality glasses device operable to offload audio processing, in accordance with some examples of the present disclosure.

FIG. 10 is a diagram of earbuds operable to offload audio processing, in accordance with some examples of the present disclosure.

FIG. 11 is a diagram of a hearing aid device operable to offload audio processing, in accordance with some examples of the present disclosure.

FIG. 12 is a diagram of a second example of a vehicle operable to support offloading audio processing, in accordance with some examples of the present disclosure.

FIG. 13 is a diagram of an example of a method of operating an audio device, in accordance with some aspects of the present disclosure.

FIG. 14 is a diagram of an example of a method of operating a host device, in accordance with some aspects of the present disclosure.

FIG. 15 is a block diagram of an illustrative example of a device that is operable to support offloading audio processing, in accordance with one or more aspects of the present disclosure.

### V. DETAILED DESCRIPTION

The above-described problems associated with power consumption and battery drain related to audio processing performed at a wearable electronic device (e.g., an audio device) are solved by offloading one or more audio processing operations from the wearable electronic device to a host device as described herein. The present disclosure provides systems, devices, apparatus, methods, and computer-readable media for offloading (e.g., delegating) one or more audio processing operations from an audio device (e.g., a wearable electronic device) to a host device. For example, the one or more audio processing operations may include or correspond to an echo cancellation (EC) operation, a noise suppression (NS) operation, pre-/post-processing (PP) operation, or a combination thereof. Some aspects more specifically relate to offloading the one or more audio processing operations based on a power indicator associated with a power status of the audio device or based on an input that indicates to offload the one or more audio processing operations. Some other aspects more specifically relate to establishing a communication session (e.g., a personal area network) between the audio device and the host device that enables peer-to-peer (P2P) communication (e.g., Bluetooth communication), wireless fidelity (WiFi) communication via a network node, or a combination thereof. In some aspects, the one or more audio processing operations are offloaded to from the audio device to the host device based on availability or verification of a WiFi link between the audio device and the host device.

In some embodiments, the audio device is configured to offload the one or more audio processing operations associated with a received audio signal, such as microphone audio data. The received audio signal may be associated with a voice call established via the host device, an input for operation or execution by the host device, or a combination thereof, as illustrative, non-limiting examples. To offload the one or more audio processing operations to the host device, the audio device can send an indicator (or request) to the host device that indicates the one or more audio processing operations or an audio processing configuration. In addition to sending the indicator, the audio device can disable or bypass the one or more audio processing operations, one or more audio components associated with the one or more audio processing operations, or a

### Combination Thereof.

In some examples, the audio device is configured to offload the one or more audio processing operations based on a power indicator that indicates a power level of a battery of the audio device, a charging status of the battery of the audio device, or a combination thereof. To illustrate, the audio device may offload the one or more audio processing operations based on a power level of the battery being less than or equal to a threshold, the charging status being a non-charging status, or a combination thereof. In some such examples, the one or more audio processing operations include clear voice communication (CVC) operations, such as the EC operations and the NS operations. In some other examples, the audio device is configured to offload the one or more audio processing operations based on an input (e.g., a user input) that indicates to offload the one or more audio processing operations or indicates a mode (e.g., a low power mode) associated with offloading of the one or more audio processing operations. In some such examples, the one or more audio processing operations include the EC operations, the NS operations, and the PP operations.

In some embodiments, the host device is configured to reject the offloading of the one or more audio processing operations from the audio device or to stop performing the one or more audio processing operations that have been offloaded by the audio device. For example, the host device may determine a power indicator, such as a power level or a charging status associated with a battery of the host device, and determine whether the host device can perform the one or more audio processing operations requested by the audio device to be offloaded to the host device. To illustrate, the host device may determine that the host device cannot perform the one or more audio processing operations requested by the audio device based on a determination that the power level of the battery of the host device is less than or equal to a threshold, the charging status of the battery of the host device being a non-charging status, or a combination thereof. Accordingly, when the battery level of the host device is low (e.g., critically low), the offloading of the one or more audio processing operations can be denied or reverted back to the audio device in order for the host device to conserve power.

Thus, the aspects described herein support offloading of one or more audio processing operations by an audio device (e.g., a wearable electronic device). A technical benefit of the disclosed aspects includes the dynamic management and offloading of audio processing tasks of the audio device based on real-time characteristics, such as power characteristics or inputs. Additionally, the audio processing tasks can be offloaded by the audio device to optimize power consumption (e.g., mitigate the battery drain) at the audio device without compromising audio quality and a user experience. Additionally, or alternatively, another technical benefit of the disclosed aspects is that the audio device may utilize a communication link (e.g., a WiFi link) to communicate audio data to the host device via a network node for the host device to perform the one or more audio processing operations offloaded to the host device. The use of the communication link via the network node may provide sufficient data transfer rate availability and achieve low latency that is needed for the audio device to provide a high-quality audio transmission and offload real-time audio processing to the host device.

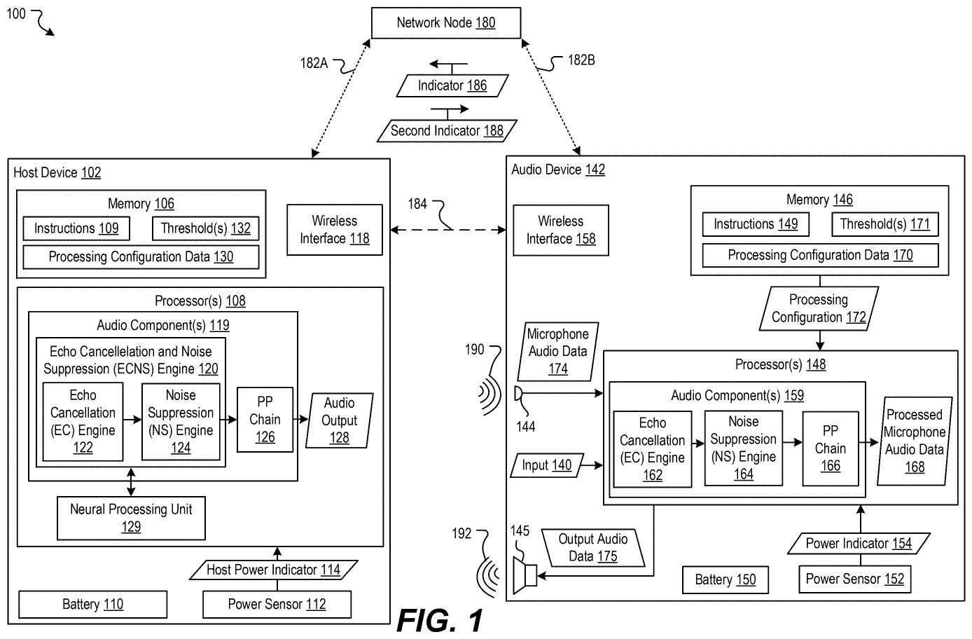

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a host device 102 including one or more processors (“processor(s)” 108 of FIG. 1), which indicates that in some implementations the host device 102 includes a single processor 108 and in other implementations the host device 102 includes multiple processors 108. For ease of reference herein, such features are generally introduced as “one or more” features and are subsequently referred to in the singular or optional plural (as indicated by “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein-e.g., when no particular one of the features is being referenced, the reference number is used without a distinguishing letter. However, when one particular feature of multiple features of the same type is referred to herein, the reference number is used with the distinguishing letter. For example, referring to FIG. 10, multiple speakers are illustrated and associated with reference numbers 1008A and 1008B. When referring to a particular one of these segments, such as a speaker 1008A, the distinguishing letter “A” is used. However, when referring to any arbitrary one of these speakers or to these speakers as a group, the reference number 1008 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

FIG. 1 is a block diagram of an example of a system 100 that supports offloading audio processing, in accordance with one or more aspects of the present disclosure. The system 100 includes a host device 102, an audio device 142, and a

### Network Node 180.

The host device 102 includes, or is coupled to, a memory 106, one or more processors 108 (collectively referred to herein as the “processor 108”), a battery 110, a power sensor 112, and a wireless interface 118. The memory 106 may include one or more memories, such as a single memory or multiple different memories (of the same type or of different types). The memory 106 includes or is configured to store instructions 109, one or more thresholds 132 (hereinafter referred to as “the threshold 132”), and processing configuration data 130. The instructions 109 that, when executed by the processor 108, cause the processor 108 to perform one or more operations as described herein. The threshold 132 includes or indicates a threshold, such as a power level threshold. The threshold 132 may be set by a user or manufacturer of the device.

The processing configuration data 130 indicates one or more audio processing configurations (for processing microphone audio data generated by a microphone 144 of the audio device 142). Each audio processing configuration may indicate, for the host device 102, the audio device 142, or both, one or more audio processing operations to be performed, one or more audio processing configurations to be bypassed, one or more audio components to be activated, one or more audio components to be deactivated (or bypassed), or a combination thereof. In some examples, at least one audio processing configuration is associated with or corresponds to a mode, such as a low power mode. Additionally, or alternatively, each audio processing configuration may be associated with a different power consumption rate. For example, a first audio processing configuration (e.g., a first mode) can have a first power consumption rate associated with the host device 102, and a second audio processing configuration (e.g., a second mode) can have a second power consumption rate associated with the host device 102 that is greater than the first power consumption rate.

In some implementations, the memory 106 is configured to buffer audio data. Alternatively, in other implementations, the host device 102 includes another memory (e.g., a buffer) that is configured to buffer the audio data.

The battery 110 is configured to store and provide power to one or more components of the host device 102. In some implementations, the battery 110 is configured to be re-chargeable. For example, the battery 110 can be charged by another power source, such as a power source that is external to the host device 102.

The power sensor 112 (e.g., a sensor) is configured to monitor or determine a power level, a charging status (e.g., charging or non-charging), or both, of the battery 110. The power sensor 112 may be configured to generate a host power indicator 114 that includes or indicates the power level of the battery 110, the charging status (e.g., a charging state), or a combination thereof. In some embodiments, the power sensor 112 is coupled to the battery 110 and configured to generate the host power indicator 114 based on a state associated with the battery 110. In some implementations, the power sensor 112 is configured to send the host power indicator 114 to another component of the host device 102, such as one or more processors (e.g., the processor 108).

Although the host device 102 is described as including the battery 110 and the power sensor 112, in other embodiments, the battery 110, the power sensor 112, or both, is external to the host device 102. For example, the battery 110 can be external to the host device 102 and coupled to the host device 102.

The processor 108 is coupled to the memory 106, the battery 110, the power sensor 112, the wireless interface 118, or a combination thereof. The processor 108 includes one or more audio components 119 (hereinafter collectively referred to as “the audio component 119”) and a neural processing unit 129. The audio component 119, or a portion thereof, may be implemented by the processor 108 executing instructions (e.g., software), dedicated hardware (e.g., circuitry), a combination thereof. The audio component 119 includes the echo cancellation and noise suppression (ECNS) engine 120 and a pre-/post-processing (PP) chain 126.

The ECNS engine 120 includes an echo cancellation (EC) engine and a noise suppression (NS) engine 124. Although the audio component 119 is described as including the ECNS engine 120, in other embodiments, the audio component 119 may not include the ECNS engine 120. In some such embodiments, the audio component 119 may still include the EC engine 122, the NS engine 124, or both. The EC engine 122 is configured to perform an echo cancellation operation. The NS engine 124 is configured to perform a filter-based noise suppression operation. For example, the NS engine 124 may be configured to reduce or eliminate background noise from an audio signal. In some embodiments, the ECNS engine 120 includes a neural network noise reduction engine, a non-neural network noise reduction engine (e.g., a filter-based noise reduction engine or circuitry), or both. For example, the ECNS engine 120 or the NS engine 124 may include a machine learning (ML)-based neural network (NN) (e.g., a neural network noise reduction engine) that is configured to perform one or more audio processing operations using the neural processing unit 129.

The PP chain 126 may include a pre-processing engine (e.g., a pre-processing block) configured to perform one or more pre-processing operations, a post-processing engine (e.g., a post-processing block) configured to perform one or more post-processing operations, or a combination thereof. The PP chain 126 may include a gain module, a filter, an infinite impulse response (IIR) filter, finite impulse response (FIR) filter, or a combination thereof, as illustrative, non-limiting examples. To illustrate, the PP chain 126 can perform a filtering operation, a conversion operation (e.g., conversion between time domain and frequency domain), a sound source separation operation, a voice enhancement operation, an event monitoring operation (e.g., wind monitoring, adverse acoustic event monitoring, etc.), other types of audio processing operations, or a combination thereof.

In some embodiments, the audio component 119 also may include a media format converter, a synchronizer, an encoder, a decoder, or a combination thereof. The media format converter is configured to convert a sampling rate of the audio input to a sampling rate of the ECNS engine 120. It is noted that if the sample rate of an audio input is at the sampling rate of the ECNS engine 120, then no conversion is performed by the media format converter. The synchronizer is configured to synchronize the audio input between one or more microphones with a reference point to enable the ECNS engine 120 to cancel noise included in or associated with the audio input. The encoder and the decoder are configured to perform encoding operations and decoding operations, respectively. In some embodiments, the audio component 119 includes an encoding chain that includes the media format converter and the synchronizer, the ECNS engine 120, the PP chain 126, and the encoder. The encoding chain is configured to receive an audio input and encode the audio input to be transmitted to another device. Additionally, or alternatively, the audio component 119 includes a decoding chain that includes the decoder, the media format converter and the synchronizer, the NS engine 124, and the PP chain 126. The decoding chain is configured to decode an encoded audio signal and provide the decoded audio signal for playout.

The neural processing unit (NPU) 129 is configured to perform or support performance of one or more audio processing operations. For example, the NPU 129 can be tailored to accelerate tasks (e.g., processing tasks or artificial intelligence (AI) tasks) and workloads, such as calculating neural network layers composed of scalar, vector, and tensor math. In some implementations, the NPU 129 includes an embedded neuron processing unit (ENPU) that is embedded in the processor 108, such as an audio processor. The audio processor may include a digital signal processor (DSP), one or more other types of processors, or a combination thereof. In some embodiments, the processor 108 includes the audio processor (e.g., the DSP), and an additional processor, such as a central processing unit (CPU). Although the host device 102 is described as being coupled to or including the NPU 129, in other embodiments, the host device 102 may not include or be coupled to the NPU 129.

The processor 108 is configured to deactivate (e.g., bypass) or activate a portion or an entirety of the audio components 119, the NPU 129, or a combination thereof, as described further herein. For example, the processor 108 may deactivate (e.g., bypass) or activate the portion or the entirety of the audio components 119 and/or the NPU 129 based on a processing configuration, an indicator received from the audio device 142, the host power indicator 114, or a combination thereof.

The wireless interface 118 is configured to enable communication between the host device 102 and another device, such as the audio device 142 and/or the network node, as illustrative, non-limiting examples. The wireless interface 118 may include a modem, a transceiver (e.g., a transmitter and/or a receiver), an antenna, or a combination thereof. In some embodiments, the wireless interface 118 includes a modem configured to send processed microphone audio data generated based on the one or more audio processing operations performed on the microphone audio data.

In some embodiments, the host device 102 includes wireless communication control circuitry. The wireless communication control circuitry may be included in the processor 108, the wireless interface 118, or a combination thereof. The wireless communication control circuitry is configured to control communication of the host device 102. For example, the wireless communication control circuitry enables the host device 102 to establish a communication session with another device. To illustrate, the communication session may include or be associated with a personal area network established with the audio device 142. Additionally, or alternatively, the wireless communication control circuitry is configured to control communication of the host device 102 via a P2P link 184 or via a WiFi link 182 (e.g., a communication link).

The host device 102 also may include or be coupled to one or more other devices or components, such as a microphone, a speaker, a display device, an input device, or a combination thereof, as illustrative non-limiting examples. The input device may include a microphone, a keyboard, or a touch screen, as illustrative, non-limiting examples.

The audio device 142 includes, or is coupled to, a memory 146, one or more processors 148 (collectively referred to herein as the “processor 148”), a microphone 144, a speaker 145, a battery 150, a power sensor 152, and a wireless interface 158. The memory 146 may include one or more memories, such as a single memory or multiple different memories (of the same type or of different types). The memory 146 includes or is configured to store instructions 149, one or more thresholds 171 (hereinafter referred to as “the threshold 171”), and processing configuration data 170. The instructions 149 that, when executed by the processor 148, cause the processor 148 to perform one or more operations as described herein. The threshold 171 includes or indicates a threshold, such as a power level threshold. The threshold 171 may be set by

### A User or Manufacturer of the Device.

The processing configuration data 170 includes or corresponds to the processing configuration data 130. For example, the processing configuration data 170 indicates one or more audio processing configurations (for processing microphone audio data generated by the microphone 144). Each audio processing configuration may indicate, for the audio device 142, one or more audio processing operations to be performed, one or more audio processing configurations to be bypassed, one or more audio components to be activated, one or more audio components to be deactivated (or bypassed), one or more audio processing operations to be offloaded to the host device 102, or a combination thereof. In some examples, at least one audio processing configuration is associated with or corresponds to a mode, such as a low power mode. Additionally, or alternatively, each audio processing configuration may be associated with a different power consumption rate. For example, a first audio processing configuration (e.g., a first mode) can have a first power consumption rate associated with the audio device 142, and a second audio processing configuration (e.g., a second mode) can have a second power consumption rate associated with the audio device 142 that is less than the first power consumption rate.

In some embodiments, the memory 146 is configured to buffer audio data. Alternatively, in other implementations, the audio device 142 includes another memory (e.g., a buffer) that is configured to buffer the audio data. For example, the other memory may be included in the processor 148.

The battery 150 is configured to store and provide power to one or more components of the audio device 142. In some implementations, the battery 150 is configured to be re-chargeable. For example, the battery 150 can be charged by another power source, such as a power source that is external to the audio device 142.

The power sensor 152 (e.g., a sensor) is configured to monitor or determine a power level, a charging status (e.g., charging or non-charging), or both, of the battery 150. The power sensor 152 may be configured to generate a power indicator 154 that includes or indicates the power level of the battery 150, the charging status (e.g., a charging state), or a combination thereof. In some embodiments, the power sensor 152 is coupled to the battery 150 and configured to generate the power indicator 154 based on a state associated with the battery 150. In some implementations, the power sensor 152 is configured to send the power indicator 154 to another component of the audio device 142, such as one or more processors (e.g., the processor 148).

Although the audio device 142 is described as including the battery 150 and the power sensor 152, in other embodiments, the battery 150, the power sensor 152, or both, is external to the audio device 142. For example, the battery 150 can be external to the audio device 142 and coupled to the audio device 142.

The processor 148 is coupled to the microphone 144, the speaker 145, the memory 146, the battery 150, the power sensor 152, the wireless interface 158, or a combination thereof. The processor 148 includes one or more audio components 159 (hereinafter collectively referred to as “the audio component 159”). The audio component 159 includes an EC engine 162, an NS engine 164, and a PP chain 166. The EC engine 162, the NS engine 164, and the PP chain 166 include or correspond to the EC engine 122, the NS engine 124, and the PP chain 126, respectively. In some embodiments, the NS engine 164 is configured to perform machine learning-based noise suppression, filter-based noise suppression, or a combination thereof. Additionally, or alternatively, in some embodiments, the audio component 159 includes a CVC engine that includes the EC engine 162 and the NS engine 164. The CVC engine may be configured to perform ECNS operations, such as machine learning-based ECNS operations. In some embodiments, the CVC engine has one or more modes depending on a number of microphones that provide microphone audio data to the processor 148.

The processor 148 is configured to deactivate (e.g., bypass) or activate a portion or an entirety of the audio components 159, as described further herein. For example, the processor 148 may deactivate (e.g., bypass) or activate the portion or the entirety of the audio components 159 based on a processing configuration, an indicator received from the host device 102, the power indicator 154, input 140, or a combination thereof. In some embodiments, the processor 148 is configured to select a processing configuration (of the one or more processing configurations indicated by the processing configuration data 170) based on the power indicator 154, as described further herein.

In some embodiments, the audio device 142 (e.g., the processor 148) includes or is coupled to an NPU, such as an embedded NPU. The NPU of the audio device 142 has a smaller processing capability as compared to the NPU 129 of the host device 102. For example, the NPU 129 of the host device can be configured to run larger and more complex models (having a first megabyte (MB) size) as compared to ENPU of audio device 142, which handles smaller models (having a second MB size that is smaller than the first MB size). The audio device 142 may be configured to offload one or more audio processing operations to the host device 102 such that the host device 102 can leverage the NPU 129 that is more powerful and more efficient than the NPU of the audio device 142. Additionally, or alternatively, the offloading of the one or more audio processing operations to the host device 102 can result in extended battery life for the audio device 142, while maintaining high audio processing performance that is leveraged from the host device 102.

The microphone 144 is configured to obtain (e.g., receive) an audio input 190 and generate the microphone audio data 174 based on the audio input 190. The speaker 145 is configured to output audio 192 based on output audio data 175. In some embodiments, the processor 148 is configured to obtain the output audio data 175 and provide the output audio data 175 to the speaker 145. For example, the processor 148 may receive the output audio data 175 from or via the host device 102.

The wireless interface 158 may include or correspond to the wireless interface 118. The wireless interface 158 is configured to enable communication between the audio device 142 and another device, such as the host device 102 and/or the network node, as illustrative, non-limiting examples. The wireless interface 158 may include a modem, a transceiver (e.g., a transmitter and/or a receiver), an antenna, or a combination thereof. In some embodiments, the wireless interface 158 includes a modem configured to send audio data, such as microphone audio data 174 or processed microphone audio data 168 (generated based on the one or more audio processing operations performed on the microphone audio data 174).

In some embodiments, the audio device 142 includes wireless communication control circuitry. The wireless communication control circuitry may be included in the processor 148, the wireless interface 158, or a combination thereof. The wireless communication control circuitry is configured to control communication of the audio device 142. For example, the wireless communication control circuitry enables the audio device 142 to establish a communication session with another device. To illustrate, the communication session may include or be associated with a personal area network established with the host device 102. Additionally, or alternatively, the wireless communication control circuitry is configured to control communication of the audio device 142 via the P2P link 184 or via the WiFi link 182.

The audio device 142 also may include or be coupled to one or more other devices or components, such as a display device, an input device, or a combination thereof, as illustrative non-limiting examples. The input device may include a microphone, a keyboard, or a touch screen, as illustrative, non-limiting examples. The input device may be configured to receive an input 140, such as a user input. Alternatively, the processor 148 may be configured to receive the input 140 from the host device 102.

The network node 180 is a station that is configured to communicate with one or more devices, such as the host device 102, the audio device 142, or a combination thereof. The network node 180 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

The network node 180 can include a variety of components (such as structural, hardware components) used for carrying out one or more functions described herein. For example, these components can include one or more processors, one or more memory devices, one or more transmitters (e.g., a transmitter), and one or more receivers (e.g., a receiver).

The one or more of the processors may be individually or collectively configurable or configured to perform various functions or operations described herein. The one or more memory devices (e.g., a memory) may be configured to store instructions. The one or more processors may be configured to execute instructions stored in the memory (of the network node 180) to perform the operations described herein.

The transmitter is configured to transmit reference signals, synchronization signals, control information, and data to one or more other devices, and the receiver is configured to receive reference signals, control information and data from one or more other devices. For example, the transmitter may transmit signaling, control information and data to, and the receiver may receive signaling, control information and data from, a device (e.g., the host device 102 or the audio device 142). In some implementations, the transmitter and the receiver may be integrated in one or more transceivers.

In some embodiments, the system 100, such as wireless communication system, is configured to implement a 5G NR network or a 6G network. For example, the system 100 may include multiple 5G-capable devices (or 6G-capable devices) and multiple 5G-capable network nodes (or 6G-capable network nodes), such as devices and network nodes configured to operate in accordance with a 5G NR network protocol, or a 6G network protocol, such as that defined by the 3GPP.

In the system 100, the host device 102 (e.g., a personal wireless communication device may communicate with network node 180 (e.g., an access point (AP)) in a wireless local area network (WLAN) via a channel, such as a 2.4 gigahertz (GHz) (also referred to as 2 GHz), 5 GHz, or 6 GHz wireless communication link. For example, the channel may include or correspond to a WiFi link.

Additionally, the host device 102 may also establish a communication session, such as a personal area network, with the audio device 142 to communicate with the audio device 142. Communication links of the personal area network may be 2.4 GHz, 5 GHz, or 6 GHz wireless communication links for reduced latency and/or high throughput applications, such as streaming audio for gaming applications, music, podcasts, or audio books, or voice calls. The personal area network, such as an expanded personal area network (XPAN), may enable the host device 102 and the audio device 142 to communicate using a peer-to-peer (P2P) link, a WiFi link (via the network node 180), or a combination thereof. For example, the host device 102 may communicate with the audio device 142 (a personal audio device—e.g., earbuds or a headset) via a P2P link 184, such as 2.4 GHz, of the personal area network. The P2P link 184, such as a direct link, may enable streaming of audio or voice calls to be provided to the audio device 142 from the host device 102. In some examples, the P2P link 184 includes a Bluetooth link. As another example, the host device 102 may also communicate with the audio device 142 in the personal area network using the WiFi link 182 (such as a 2.4 GHz, 5 GHz or 6 GHz wireless communication links) between the host device 102and the audio device 142. Communication between the host device 102 and the audio device 142 via the WiFi link 182 may occur via the network node 180 (e.g., an AP). The network node 180 may may have a larger range than host device 102, and accordingly, the network node 180 may be used to stream audio or voice calls to the audio device 142 instead of using a direct link (the P2P link 184) between the audio device 142 and the host device 102.

In some embodiments, to provide the WiFi communication between the audio device 142 and the host device 102 as part of the personal area network, the audio device 142 may associate with the network node 180 and receive an internet protocol (IP) address from the network node 180, which the audio device 142 then sends with the host device 102. Once the audio device 142 is connected with the network node 180, the audio device 142 may transmit a disassociation message to the host device 102, and may communicate with the host device 102 via the network node 180. When communicating with the host device 102 via a network node 180, the audio device 142 and/or the host device 102 may initiate a transition back to use of the P2P link 184. Additionally, or alternatively, when communicating with the host device 102 via a first network node (e.g., a first AP), the audio device 142 may transition to a connection with a second network node, for example, based on a link quality of the link with the second network node being stronger than a link quality of the link with the first network node.

During operation of the system 100, the host device 102 and the audio device 142 establish a communication session. For example, the host device 102 and the audio device may establish a personal area network, such as an XPAN. The personal area network may include the P2P link 184, the WiFi link 182, or a combination thereof. The WiFi link 182 may be established between the audio device 142 and the host device 102 via the network node 180. For example, the WiFi link 182 includes a first portion 182B between the audio device 142 and the network node 180, and a second portion 182A between the host device 102 and the network node 180. In some embodiments, to establish the communication session, the host device 102 and the audio device 142 establish the P2P link 184 prior to the WiFi link 182.

The host device 102 and the audio device 142 may communicate data, such as audio data, control data, etc., using the personal area network. For example, the host device 102 and the audio device 142 may communicate audio data via the P2P link 184, the WiFi link 182, or a combination thereof.

In some embodiments, a voice call is established via the host device 102 with another device. For example, the voice call may be associated with telephonic communication between a user of the host device 102 (and the audio device 142) and the other device over one or more wired or wireless communication networks (e.g., long-term evolution (LTE), New Radio (NR), etc.) (LTE is a trademark of European Telecommunications Standards Institute). Additionally, or alternatively, the voice call is over at least one of an NR network, a 5G network, a beyond 5G wireless network, or a combination thereof. Output audio (of the voice call) received at the host device 102 from the other device is provided to the audio device 142 for playout via the speaker 145 of the audio device 142. Input audio (of the voice call) is received via the microphone 144 and provided from the audio device 142 to the host device 102 for the host device 102 to send to the other device participating in the voice call.

During the communication session, the audio device 142 may configure the audio component 159 based on a processing configuration 172 selected from one or more processing configurations indicated by or included in the processing configuration data 170. The processing configuration 172 indicates one or more audio processing operations to be performed by the audio device, 142, one or more audio processing operations to be offloaded from the audio device 142 to the host device 102, or a combination thereof.

In some embodiments, the audio component 159 is configured according to a first processing configuration in which the EC engine 162, the NS engine 164, and the PP chain 166 are activated to process microphone audio data 174 and generate processed microphone audio data 168. The audio device 142 sends the processed microphone audio data 168 to the host device 102 via the P2P link 184, the WiFi link 182, or a combination thereof.

In some embodiments, the audio device 142 selects a second processing configuration that indicates to offload ECNS processing (e.g., to bypass or disable the EC engine 162 and the NS engine 164) based on a power indicator 154. Offloading the ECNS processing can reduce a power consumption of the battery 150 by a first amount as compared to a power consumption of the battery 150 when the audio component 159 is configured according to the first processing configuration. To illustrate, the processor 148 receives the power indicator 154 that indicates a charging status of the battery 150, a power level of the battery 150, or a combination thereof. The processor 148 may determine whether the charging status of the battery 150 is in a charging state or a non-charging state, whether the power level of the battery 150 satisfies a power level threshold (e.g., the threshold 171), or a combination thereof. The processor 148 device can select the second processing configuration based on a determination that the charging status of the battery 150 is the non-charging state, a determination that the power level of the battery 150 satisfies the power level threshold (e.g., the power level is less than or equal to a power level threshold), or a combination thereof.

To configure the audio component 159 according to the second processing configuration, the processor 148 bypasses or disables the EC engine 162 and the NS engine 164. The audio component 159 configured according to the second processing configuration receives the microphone audio data 174 and generates the processed microphone audio data 168 based on the PP chain 166. The audio device 142 sends the processed microphone audio data 168 to the host device 102 via the P2P link 184, the WiFi link 182, or a combination thereof.

In some embodiments, the audio device 142 selects a third processing configuration that indicates to offload ECNS and PP processing (e.g., to bypass or disable the EC engine 162, the NS engine 164, and the PP chain 166) based on an input 140. Offloading the ECNS and PP processing can reduce a power consumption of the battery 150 by a second amount as compared to a power consumption of the battery 150 when the audio component 159 is configured according to the first processing configuration. To illustrate, the processor 148 receives an input 140 (received via a user interface of the host device 102 or the audio device 142). The processor 148 may determine whether the input 140 indicates to use or enter a mode, such as a low power mode. The processor 148 device can select the third processing configuration based on a determination that the input indicates to use or enter the mode—e.g., the low power mode. In some examples, the second amount (associated with the third processing configuration) is a greater amount than the first amount (associated with the second processing configuration.

To configure the audio component 159 according to the third processing configuration, the processor 148 bypasses or disables the EC engine 162, the NS engine 164, and the PP chain 166. The audio component 159 configured according to the third processing configuration receives the microphone audio data 174 and provides the microphone audio data 174 as the processed microphone audio data 168—e.g., the audio component 159 does not perform audio processing operations on the microphone audio data 174. The audio device 142 sends the processed microphone audio data 168 (e.g., the microphone audio data 174) to the host device 102 via the P2P link 184, the WiFi link 182, or a combination thereof.

The audio device 142 generates and sends an indicator 186 to the host device 102 via the P2P link 184, the WiFi link 182, or a combination thereof. The indicator 186 may indicate the processing configuration 172, such as the first processing configuration, the second processing configuration, or the third processing configuration. In some implementations, the indicator 186 includes a request for the host device 102 to implement a processing configuration in order for the audio device 142 to offload the one or more audio processing operations to the host device 102. Additionally, or alternatively, the indicator 186 may indicate that the audio device 142 and the host device 102 are to communicate via the WiFi link 182. For example, the indicator 186 may indicate to use the WiFi link 182 when the processing configuration 172 is the second processing configuration or the third processing configuration.

The host device 102 receives the indicator 186 and configures the audio component 119 based on the processing configuration 172 indicated by the indicator 186. For example, the processor 108 may receive the indicator 186 and select or determine the processing configuration 172 indicated by the indicator 186. Additionally, or alternatively, the processor 108 may select, based on the indicator 186, a processing configuration from one or more processing configurations associated with the processing configuration data 130, and configure the audio component 119 based on the selected processing configuration.

In some examples, based on the indicator 186 indicating the first configuration, the audio component 119 is bypassed or deactivated—e.g., the ECNS engine 120 and the PP chain 126 are bypassed or deactivated. The host device 102 having the audio component 119 configured according to the first processing configuration receives the processed microphone audio data 168 from the audio device 142 via the P2P link 184 or the WiFi link 182. The host device 102 may perform one or more operations based on the received microphone audio data 168 and/or may send the processed microphone audio data 168 to another device.

In some other examples, based on the indicator 186 indicating the second configuration, the processor 108 configures the audio component 119 to activate the ECNS engine 120 (e.g., the EC engine 122 and the NS engine 124) and to bypass or deactivate the PP chain 126. The host device 102 having the audio component 119 configured according to the second processing configuration receives the processed microphone audio data 168 from the audio device 142, such as via the WiFi link 182. The host device 102 may provide the received processed microphone audio data 168 to the audio component 119 and perform one or more audio processing operations based on the second processing configuration to generate the audio output 128. The host device 102 may perform one or more operations based on the audio output 128 and/or may send the audio output 128 to another device.

In some other examples, based on the indicator 186 indicating the third configuration, the processor 108 configures the audio component 119 to activate the ECNS engine 120 (e.g., the EC engine 122 and the NS engine 124) and the PP chain 126. The host device 102 having the audio component 119 configured according to the third processing configuration receives the processed microphone audio data 168 (e.g., the microphone audio data 174) from the audio device 142, such as via the WiFi link 182. The host device 102 may provide the received processed microphone audio data 168 (e.g., the microphone audio data 174) and to the audio component 119 and perform one or more audio processing operations based on the third processing configuration to generate the audio output 128. The host device 102 may perform one or more operations based on the audio output 128 and/or may send the audio output 128 to another device.

The host device 102 (e.g., the processor 108) receives a host power indicator 114 that indicates a charging status of the battery 110, a power level of the battery 110, or a combination thereof. The processor 108 may determine whether the charging status of the battery 110 is in a charging state or a non-charging state, whether the power level of the battery 110 satisfies a power level threshold (e.g., the threshold 132), or a combination thereof.

In some embodiments, the processor 108 can determine whether or not to implement the processing configuration indicated by the indicator 186 based on the charging status of the battery 110, the power level of the battery 110, or a combination thereof. For example, the processor 108 may not implement the processing configuration (e.g., the second configuration or the third configuration) indicated by the indicator 186 based on a determination that the charging status of the battery 110 is the non-charging state, a determination that the power level of the battery 110 satisfies the power level threshold (e.g., the power level is less than or equal to a power level threshold), or a combination thereof. If the processor 108 determines to not implement the processing configuration (e.g., the second configuration or the third configuration) indicated by the indicator 186, the host device 102 sends a second indicator 188 to the audio device 142 that indicates that the host device 102 is not going to implement the processing configuration (e.g., the second configuration or the third configuration) indicated by the indicator 186, that the audio device 142 is to implement the first processing configuration (e.g., to activate the EC engine 162, the NS engine 164, and the PP chain 166), or a combination thereof. The host device 102 can send the second indicator 188 to the audio device 142 via the P2P link 184, the WiFi link 182, or a

### Combination Thereof.

In some embodiments, after the audio component 119 is configured based on the second processing configuration or the third processing configuration, the host device 102 receives the host power indicator 114 and determines whether or not to maintain the configuration of the audio component 119. For example, the processor 108 may not maintain the processing configuration (e.g., the second configuration or the third configuration) based on a determination that the charging status of the battery 110 is the non-charging state, a determination that the power level of the battery 110 satisfies the power level threshold (e.g., the power level is less than or equal to a power level threshold), or a combination thereof. If the processor 108 determines to not maintain the processing configuration (e.g., the second configuration or the third configuration), the host device 102 sends the second indicator 188 to the audio device 142 that indicates for the audio device 142 to implement the first processing configuration (e.g., to activate the EC engine 162, the NS engine 164, and the PP chain 166).

The audio device 142 may receive the second indicator 188 from the host device 102 and configure the audio component 159 based on the second indicator 188. For example, the processor 148 can activate the EC engine 162, the NS engine 164, and the PP chain 166 and process the microphone audio data 174 based on the EC engine 162, the NS engine 164, and the PP chain 166 to generate the processed microphone audio data 168. The audio device 142 transmits the processed microphone audio data 168 to the host device 102 via the P2P link 184, the WiFi link 182, or a combination thereof.

In some embodiments, the host device 102 sends the host power indicator 114 to the audio device 142. For example, the host device 102 may send the host power indicator 114 to the audio device 142 prior to the host device 102 receiving the indicator 186 from the audio device 142. In some such embodiments, the audio device 142 may select the processing configuration 172 based on the host power indicator 114. For example, the audio device 142 may select the second processing configuration or the third processing configuration based on the host power indicator 114 indicating that the battery 110 is charging, based on the power level of the battery 110 being greater than or equal to a threshold power level, or a combination thereof. Additionally, or alternatively, the audio device 142 may select a processing configuration based on the availability or establishment of the WiFi link 182. For example, the audio device 142 may select or determine that the second processing configuration and/or the third processing configuration is available based on the WiFi link 182 being available or established.

Although one or more operations are described herein as being performed at or by the audio device 142, in other implementations, the one or more operations may be performed at or by another device, such as the host device 102. For example, the audio device 142 may send the power indicator 154 to the host device 102 and the host device 102 may determine or select the processing configuration 172 to be implemented at or by the host device 102 and/or the audio device 142. Additionally, or alternatively, although one or more operations are described herein as being performed at or by the host device 102, in other implementations, the one or more operations may be performed at or by another device, such as the audio device 142. For example, the host device 102 may send the host power indicator 114 to the audio device 142 and the audio device 142 may determine whether or not the host device 102 will implement or cease implementation of a processing configuration selected by the audio device 142.

In some examples, the host device 102 corresponds to or is included in one of various types of devices, such that the processor 108 can be integrated in multiple types of devices. In an illustrative example, the processor 108 is integrated in a mobile device (a mobile phone or a tablet) as depicted in FIG. 4, a voice-controlled speaker system as depicted in FIG. 7, a vehicle as depicted in FIG. 12, a computer (e.g., a desktop computer) or a server, or another system or device.

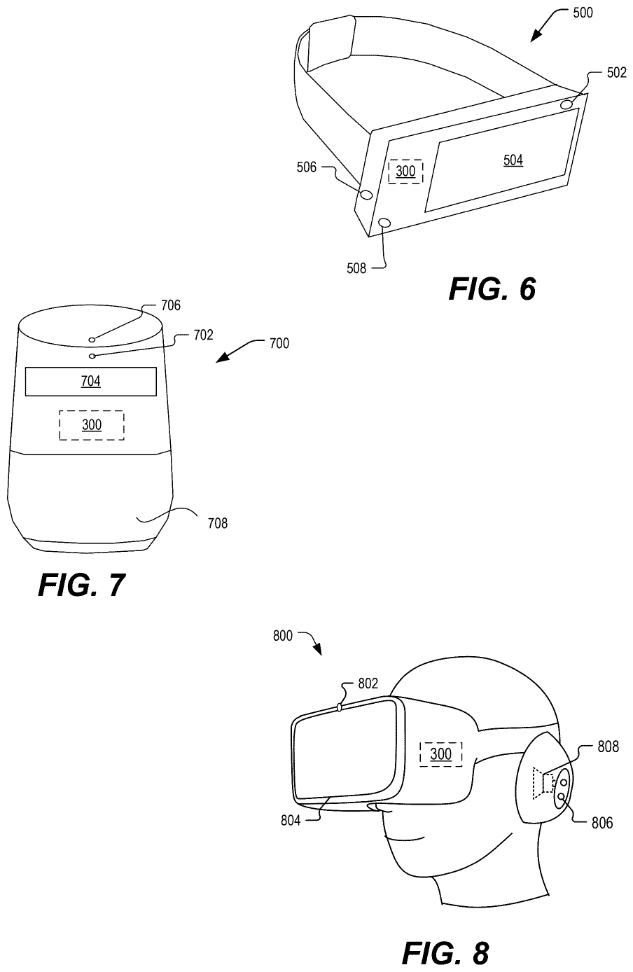

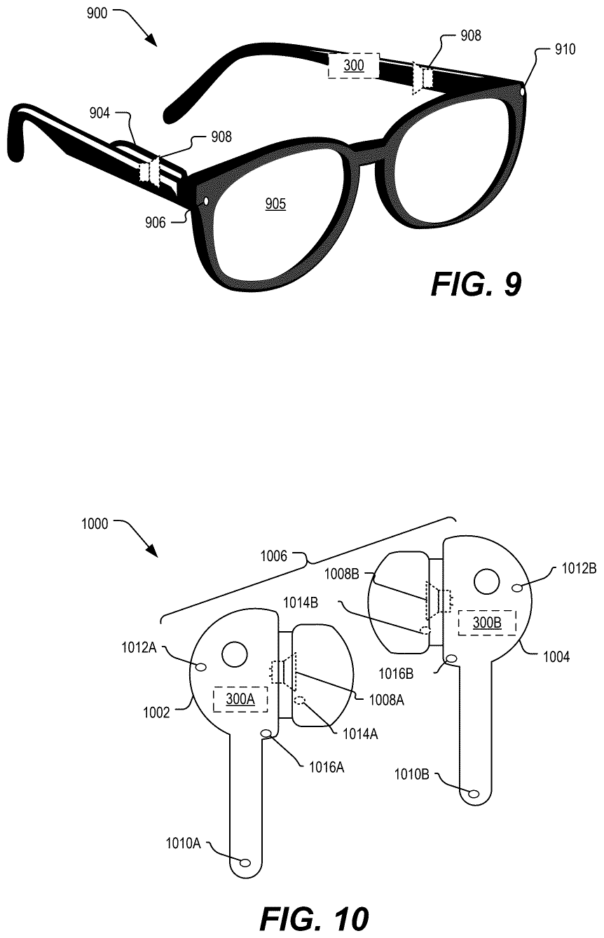

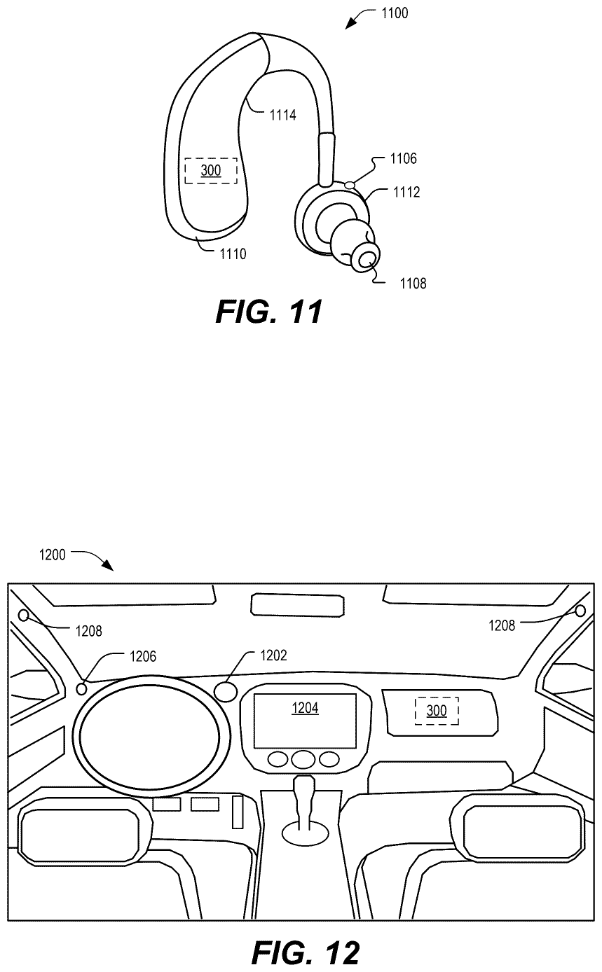

In some examples, the audio device 142 corresponds to or is included in one of various types of devices, such that the processor 148 can be integrated in multiple types of devices. In an illustrative example, the processor 148 is integrated in a wearable device, such as a headset as depicted in FIG. 5, a wearable electronic device as depicted in FIG. 6, a virtual reality, mixed reality, or augmented reality headset as depicted in FIG. 8, a mixed reality or augmented reality glasses device as described with reference to FIG. 9, earbuds as described with reference to FIG. 10, a hearing aid device as described with reference to FIG. 11, or another wearable device.

One technical advantage of implementing the host device 102, the audio device 142, or a combination thereof, as described above is that the audio device 142 (e.g., a wearable electronic device) can offload one or more audio processing operations from the audio device 142 to the host device 102. For example, the audio device 142 and/or the host device 102 can dynamically manage offloading of one or more audio processing tasks of the audio device 142 based on real-time characteristics, such as power characteristics or inputs. In some aspects, as a technical benefit, the one or more audio processing tasks are offloaded by the audio device 142 to optimize power consumption (e.g., mitigate the battery drain) at the audio device 142 without compromising audio quality and a user experience. To illustrate, offloading the one or more audio processing tasks of the audio device 142 can reduce power consumption during a voice call, which can decrease the discharge rate of the battery 150, increase the usage time of the audio device 142 before having to recharge the battery 150, improve a user experience, or a combination thereof. For example, offloading the one or more audio processing operations from the audio device 142 to the host device 102 can beneficially reduce a power consumption at the audio device 142. Additionally, or alternatively, another technical benefit of the disclosed aspects is that the audio device 142 may utilize a communication link (e.g., a WiFi link) to communicate audio data to the host device 102 via the network node 180 to enable sufficient data transfer rate availability and achieve low latency that is needed for the audio device 142 to provide a high-quality audio transmission and offload real-time audio processing to the host device 102.

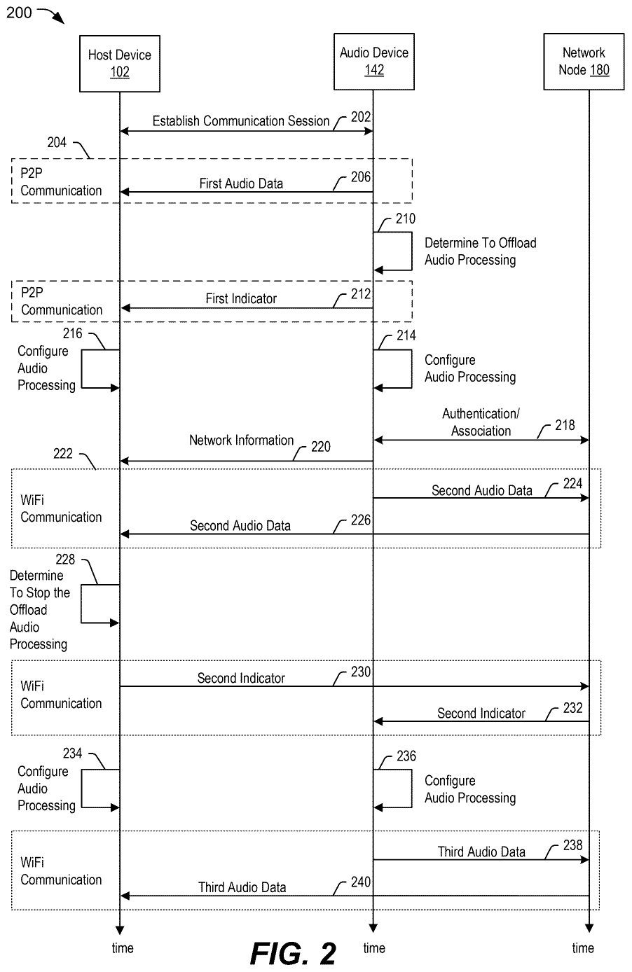

FIG. 2 depicts a ladder diagram of an example of operation of a system 200 that supports offloading audio processing, in accordance with some examples of the present disclosure. The system 200 may include or correspond to the system 100 of FIG. 1.

The system 200 includes the host device 102, the audio device 142, and the network node 180. During operation of the system 200, at 202, the host device 102 and the audio device 142 establish a communication session. For example, the audio device 142 may establish the communication session with the host device 102 via a wireless communication transceiver of the audio device 142. As another example, the host device 102 may establish the communication with the audio device 142 via a wireless transceiver of the host device 102.

The communication session is associated with a personal area network. The personal area network may include a P2P link between the host device 102 and the audio device 142, a WiFi link between the host device 102 and the audio device 142 via the network node 180, or a combination thereof. The P2P link and the WiFi link may include or correspond to the P2P link 184 and the WiFi link 182, respectively.

At 204, during operation of the system 200, the host device 102 and the audio device 142 engage in P2P communication. For example, at 206, the audio device 142 transmits first audio data to the host device 102 via a P2P link. The first audio data may be based on an audio input received by a microphone, such as the audio input 190 received by the microphone 144. The first audio data may include or correspond to the microphone audio data 174 or the processed microphone audio data 168.

At 210, the audio device 142 determines to offload one or more audio processing operations to the host device 102. The one or more audio processing operations include ECNS operations, a pre-processing operation, a post-processing operation, or a combination thereof. In some embodiments, the audio device 142 determines to offload the one or more processing operations based on a power indicator or an input. The power indicator and the input may include or correspond to the power indicator 154 and

### The Input 140, Respectively.

In some embodiments, the one or more audio processing operations that are selected to be offloaded from the audio device 142 (e.g., bypassed or deactivated by the audio device 142) include the ECNS processing operations. In some other embodiments, the one or more audio processing operations that are selected to be offloaded from the audio device 142 (e.g., bypassed or deactivated by the audio device 142) include the ECNS processing operations and one or more pre-/pos-processing operations.

At 212, the audio device 142 transmits a first indicator to the host device 102. The first indicator may include or indicate the one or more audio processing operations to be offloaded from the audio device 142 to the host device 102. For example, the first indicator may include or correspond to the indicator 186. In some implementations, the first indicator indicates a processing configuration associated with or to be implemented by the host device 102, the audio device 142, or a combination thereof, to enable the one or more audio processing operations to be offloaded from the audio device 142 to the host device 102.

At 214, the audio device 142 configures one or more audio components of the audio device 142 based on the one or more audio processing operations to be offloaded to the host device 102. For example, the audio device 142 may bypass or deactivate the one or more audio components of the audio device 142. In some embodiments, the audio device 142 may deactivate an echo canceler, a noise reducer, a pre-processing unit, a post-processing unit, or a combination thereof to selectively bypass the one or more audio processing operations. The one or more audio components may include or correspond to the audio components 159.

At 216, the host device 102 configures one or more audio components of the host device 102 to perform the one or more audio processing operations to be offloaded to the host device 102. For example, the host device 102 may activate the one or more audio components of the host device 102. In some embodiments, the host device 102 may activate an echo canceler, a noise reducer, a pre-processing unit, a post-processing unit, or a combination thereof to perform the one or more audio processing operations to be offloaded from the audio device 142 to the host device 102. The one or more audio components of the host device 102 may include or correspond to the audio components 119.

At 218, the audio device 142 and the network node 180 perform an authentication/association exchange for the audio device 142 to associate with the network node 180 for WiFi communication. Based on or during the authentication/association, the audio device 142 receives network information, such as an IP address, from the network node 180.

At 220, the audio device 142 transmits the network information to the host device 102. For example, the audio device 142 transmits the IP address (received by the audio device 142 from the network node 180) to the host device 102 to enable WiFi communication between the audio device 142 and the host device 102 via the network node 180.

At 222, during operation of the system 200, the host device 102 and the audio device 142 engage in WiFi communication via a WiFi link, such as the WiFi link 182. For example, at 224, the audio device 142 transmits second audio data to the network node 180 and, at 226, the network node 180 transmits the second audio data to the host device 102. The second audio data may include or correspond to the microphone audio data 174 or the processed microphone audio data 168. The host device 102 may perform the one or more audio processing operations on the received second audio data.

At 228, the host device 102 determines to stop the one or more audio processing operations that have been offloaded to the host device 102 to the audio device 142. For example, the host device 102 may obtain a power indicator, such as the host power indicator 114, and determine to stop the one or more audio processing operations based on the power indicator.

Based on the determination to stop the one or more audio processing operations, the host device 102 generates a second indicator that indicates that the host device 102 will cease the one or more audio processing operations that have been offloaded to the host device 102 from the audio device 142. The host device 102 may transmit the second indicator to the audio device 142 via WiFi communication. For example, at 230, the host device 102 transmits the second indicator to the network node 180 and, at 232, the network node 180 transmits the second indicator to the audio device 142. Alternatively, the host device 102 may transmit the second indicator to the audio device via P2P communication.

At 234, the host device 102 configures one or more audio components of the host device 102 to stop performing the one or more audio processing operations that were offloaded to the host device 102 by the audio device 142. For example, the host device 102 may bypass or deactivate the one or more audio components of the host device 102.

At 236, the audio device 142 configures, based on the second indicator, the one or more audio components of the audio device 142 to perform the one or more audio processing operations. For example, the audio device 142 may activate the one or more audio components of the audio device 142.

After the audio device 142 is configured to perform the one or more audio processing operations, the audio device 142 may generate third audio data based on the one or more audio processing operations. The third audio data may include or correspond to the microphone audio data 174 or the processed microphone audio data 168. The audio device 142 may transmit the third audio data to the host device 102 via WiFi communication. For example, at 238, the audio device 142 transmits third audio data to the network node 180 and, at 240, the network node 180 transmits the third audio data to the host device 102.

It is noted that although one or more operations of FIG. 2 are described as a sequential process, many of the operations can be performed in parallel or concurrently. In addition, the order of the operations may be re-arranged. For example, the operations at 218 and 220 may be performed before the operations at 214 and 216. Additionally, or alternatively, one or more of the operations may be omitted. For example, the operations at 206 may be omitted.

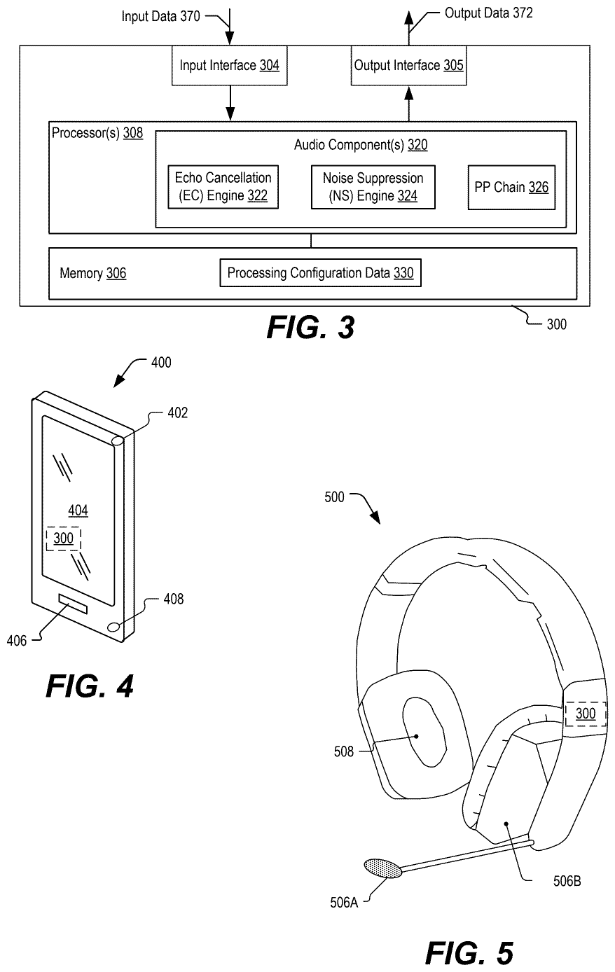

FIG. 3 depicts a diagram of an example of an integrated circuit 300 operable to support offloading audio processing, in accordance with some examples of the present disclosure. The integrated circuit 300 is configured to be included in a device, such as the host device 102 or the audio device 142, as illustrative, non-limiting examples.

The integrated circuit 300 includes one or more processors 308 (herein after referred to as the “processor 308”) and a memory 306. The processor 308 and the memory 306 may include or correspond to the processor 108 or 148 and the memory 106 or 146, respectively. The processor 308 may include one or more audio components 320 (hereinafter referred to collectively as “the audio component 320”). The audio component 320 may include or correspond to the audio component 119 or 148. The audio component 320 may include an EC engine 322, an NS engine 324, and a PP chain 326. The EC engine 322, the NS engine 324, and the PP chain 326 may include or correspond to the EC engine 122 or 162, the NS engine 124 or 164, and the PP chain 126 or 166, respectively. In some embodiments, the processor 308 may also include an NPU, such as the NPU 129.

The memory 306 includes (e.g., stores) processing configuration data 330. The processing configuration data 330 may include or correspond to the processing configuration data 130 or 170. In some embodiments, the memory 306 may also include one or more thresholds, such as the threshold 132 or 171. Although the integrated circuit 300 is described as including the memory 306 and the processing configuration data 330, in other embodiments, the memory 306 or the processing configuration data 330 may not be included in the integrated circuit 300.

The integrated circuit 300 also includes an input interface 304, such as one or more bus interfaces, to enable the integrated circuit 300 to receive signals representing input data 370 for processing. For example, the input data 370 can correspond to or include the host power indicator 114, the input 140, the power indicator 154, the processed microphone audio data 168, the processing configuration 172, the microphone audio data 174, the output audio data 175, the indicator 186, the second indicator 188, or a combination thereof.

The integrated circuit 300 also includes an output interface 305, such as a bus interface, to enable the integrated circuit 300 to output signals representing output data 372. For example, the output data 372 can correspond to or include the host power indicator 114, the input 140, the power indicator 154, the processed microphone audio data 168, the processing configuration 172, the microphone audio data 174, the output audio data 175, the indicator 186, the second indicator 188, or a combination thereof.

The integrated circuit 300 including the audio component 320 enables implementation of offloading audio processing in a system or a device. For example, the system or the device may include a mobile device (e.g., a mobile phone or tablet) as depicted in FIG. 4, a headset as depicted in FIG. 5, a wearable electronic device as depicted in FIG. 6, a voice-controlled speaker system as depicted in FIG. 7, a virtual reality, mixed reality, or augmented reality headset as depicted in FIG. 8, a mixed reality or augmented reality glasses device, as described with reference to FIG. 9, earbuds, as described with reference to FIG. 10, a hearing aid device, as described with reference to FIG. 11, or a vehicle as depicted in FIG. 12.

In some embodiments, the system or the device that includes the integrated circuit 300 also includes or is coupled to an image sensor (e.g., a camera), an input device (e.g., a microphone, a keyboard or touch screen, etc.), a display device, a speaker, a modem, or a combination thereof. In some embodiments, the system or the device that includes the integrated circuit 300 is operable to perform one or more operations described herein with reference to the host device 102. In other embodiments, the system or the device that includes the integrated circuit 300 is operable to perform one or more operations described herein with reference to the audio device 142.

FIG. 4 depicts a diagram of a mobile device 400 operable to support offloading audio processing, in accordance with some examples of the present disclosure. For example, the mobile device 400 may include or correspond to the host device 102 that is configured to support offloading of audio processing from the audio device 142 to the host device 102. The mobile device 400 may include or correspond to a phone or a tablet, as illustrative, non-limiting examples. The mobile device 400 includes a camera 402 (e.g., an image sensor), a display 404 (e.g., a display screen), a microphone 406, a speaker 408, and the integrated circuit 300. Components of the integrated circuit 300, including the audio component 320, are integrated in the mobile device 400 and are illustrated using dashed lines to indicate internal components that are not generally visible to a user of the mobile device 400.

In a particular example, the integrated circuit 300 of the mobile device 400 is operable to receive a request or an indicator (e.g., the indicator 186) from an audio device and to activate at least a portion of the audio component 320 to perform one or more audio processing operations offloaded from the audio device to the mobile device 400. The integrated circuit 300 of the mobile device 400 is operable to receive audio data, such as the microphone audio data 174 or the processed microphone audio data 168, from the audio device and perform the one or more audio processing operations using the activated portion of the audio component 320 on the received audio data. Performing the one or more audio processing operations offloaded from the audio device to the mobile device 400 enables dynamic offloading of the one or more audio processing operations based on real-time characteristics, such as power characteristics or inputs.

FIG. 5 depicts a diagram of a headset device 500 operable to offload audio processing, in accordance with some examples of the present disclosure. For example, the headset device 500 may include or correspond to the audio device 142 that is configured to support offloading of audio processing from the audio device 142 to the host device 102. The headset device 500 includes one or more microphones 506 and one or more speakers 508. In some examples, the microphones 506 include an input microphone 506A and an inner ear, or bone conduction, microphone 506B. Components of the integrated circuit 300, including the audio component 320, are integrated in the headset device 500.

In a particular example, the integrated circuit 300 of the headset device 500 is operable to bypass or deactivate at least a portion of the audio component 320 and to send an indicator, such as the indicator 186, or a request to a host device to perform one or more audio processing operations associated with the bypassed or deactivated portion of the audio component 320. Additionally, the headset device 500 is operable to obtain audio data representing sound captured by the microphone(s) 506, and to send the audio data or processed audio data (e.g., the microphone audio data 174 or the processed microphone audio data 168) to the host device. For example, the audio data may be provided to the integrated circuit 300 (having at least the portion of the audio component 320 bypassed or deactivated) prior to sending the audio data or the processed audio data to the host device. Offloading the one or more audio processing operations to the host device enables the headset device 500 to reduce power consumption (e.g., mitigate the battery drain) at the headset device 500 and increase a usage time (of a battery) of the headset device 500 without compromising audio quality and a user experience.

FIG. 6 depicts a diagram of a wearable electronic device 600 operable to offload audio processing, in accordance with some examples of the present disclosure. For example, the wearable electronic device 600 may include or correspond to the audio device 142 that is configured to support offloading of audio processing from the audio device 142 to the host device 102. The wearable electronic device 600 may include or correspond to a “smart watch,” as an illustrative, non-limiting example. The wearable electronic device 600 includes a camera 602 (e.g., an image sensor), a display 604 (e.g., a display screen), a microphone 606, a speaker 608, and the integrated circuit 300. Components of the integrated circuit 300, including the audio component 320, is integrated in the wearable electronic device 600 and are illustrated using dashed lines to indicate internal components that are not generally visible to a user of the wearable electronic device 600.

In a particular example, the integrated circuit 300 of the wearable electronic device 600 is operable to bypass or deactivate at least a portion of the audio component 320 and to send an indicator, such as the indicator 186, or a request to a host request for the host device to perform one or more audio processing operations associated with the bypassed or deactivated portion of the audio component 320. Additionally, wearable electronic device 600 is operable to obtain audio data representing sound captured by the microphone(s) 606, and to send the audio data or processed audio data (e.g., the microphone audio data 174 or the processed microphone audio data 168) to the host device. For example, the audio data may be provided to the integrated circuit 300 (having at least the portion of the audio component 320 bypassed or deactivated) prior to sending the audio data or the processed audio data to the host device. Offloading the one or more audio processing operations to the host device enables the wearable electronic device 600 to reduce power consumption (e.g., mitigate the battery drain) at the wearable electronic device 600 and increase a usage time (of a battery) of the wearable electronic device 600 without compromising audio quality and a user experience.

FIG. 7 is a diagram of a voice-controlled speaker system 700 operable to support offloading audio processing, in accordance with some examples of the present disclosure. For example, the voice-controlled speaker system 700 may include or correspond to the audio device 142 that is configured to support offloading of audio processing from the audio device 142 to the host device 102. The voice-controlled speaker system 700 may include or correspond to a wireless speaker and voice activated device, as an illustrative, non-limiting example. The voice-controlled speaker system 700 can have wireless network connectivity and is configured to execute an assistant operation. The voice-controlled speaker system 700 includes a camera 702 (e.g., an image sensor), a display 704 (e.g., a display screen), a microphone 706, a speaker 708, and the integrated circuit 300. Components of the integrated circuit 300, including the audio component 320, are integrated in the voice-controlled speaker system 700 and are illustrated using dashed lines to indicate internal components that are not generally visible to a user of the voice-controlled speaker system 700.

In a particular example, the integrated circuit 300 of the voice-controlled speaker system 700 is operable to bypass or deactivate at least a portion of the audio component 320 and to send an indicator, such as the indicator 186, or a request to a host request for the host device to perform one or more audio processing operations associated with the bypassed or deactivated portion of the audio component 320. Additionally, the voice-controlled speaker system 700 is operable to obtain audio data representing sound captured by the microphone(s) 706, and to send the audio data or processed audio data (e.g., the microphone audio data 174 or the processed microphone audio data 168) to the host device. For example, the audio data may be provided to the integrated circuit 300 (having at least the portion of the audio component 320 bypassed or deactivated) prior to sending the audio data or the processed audio data to the host device. Offloading the one or more audio processing operations to the host device enables the voice-controlled speaker system 700 to reduce power consumption (e.g., mitigate the battery drain) at the voice-controlled speaker system 700 and increase a usage time (of a battery) of the voice-controlled speaker system 700 without compromising audio quality and a user experience.

FIG. 8 is a diagram of a headset 800, such as a virtual reality, mixed reality, or augmented reality headset, operable to offload audio processing, in accordance with some examples of the present disclosure. For example, the headset 800 may include or correspond to the audio device 142 that is configured to support offloading of audio processing from the audio device 142 to the host device 102. A visual interface device is positioned in front of the user's eyes to enable display of augmented reality, mixed reality, or virtual reality images or scenes to the user while the headset 800 is worn. The headset 800 also includes a camera 802 (e.g., an image sensor), a display 804 (e.g., a display screen), a microphone 806, a speaker 808, and the integrated circuit 300. Components of the integrated circuit 300, including the audio component 320, are integrated in the headset 800 and are illustrated using dashed lines to indicate internal components that are not generally visible to a user of the headset 800.

In a particular example, the integrated circuit 300 of the headset 800 is operable to bypass or deactivate at least a portion of the audio component 320 and to send an indicator, such as the indicator 186, or a request to a host request for the host device to perform one or more audio processing operations associated with the bypassed or deactivated portion of the audio component 320. Additionally, headset 800 is operable to obtain audio data representing sound captured by the microphone(s) 806, and to send the audio data or processed audio data (e.g., the microphone audio data 174 or the processed microphone audio data 168) to the host device. For example, the audio data may be provided to the integrated circuit 300 (having at least the portion of the audio component 320 bypassed or deactivated) prior to sending the audio data or the processed audio data to the host device. Offloading the one or more audio processing operations to the host device enables the headset 800 to reduce power consumption (e.g., mitigate the battery drain) at the headset 800 and increase a usage time (of a battery) of the headset 800 without compromising audio quality and a user experience.

FIG. 9 is a diagram of a mixed reality or augmented reality glasses device 900 operable to offload audio processing, in accordance with some examples of the present disclosure. For example, the glasses 900 may include or correspond to the audio device 142 that is configured to support offloading of audio processing from the audio device 142 to the host device 102. The glasses 900 include a holographic projection unit 904 configured to project visual data onto a surface of a lens 905 or to reflect the visual data off of a surface of the lens 905 and onto the wearer's retina. The glasses 900 also include a camera 902 (e.g., an image sensor), a microphone 906, a speaker 908, and the integrated circuit 300. Components of the integrated circuit 300, including the audio component 320, are integrated in the glasses 900 and are illustrated using dashed lines to indicate internal components that are not generally visible to a user of the glasses 900.

In a particular example, the integrated circuit 300 of the glasses 900 is operable to bypass or deactivate at least a portion of the audio component 320 and to send an indicator, such as the indicator 186, or a request to a host request for the host device to perform one or more audio processing operations associated with the bypassed or deactivated portion of the audio component 320. Additionally, the glasses 900 is operable to obtain audio data representing sound captured by the microphone(s) 906, and to send the audio data or processed audio data (e.g., the microphone audio data 174 or the processed microphone audio data 168) to the host device. For example, the audio data may be provided to the integrated circuit 300 (having at least the portion of the audio component 320 bypassed or deactivated) prior to sending the audio data or the processed audio data to the host device. Offloading the one or more audio processing operations to the host device enables the glasses 900 to reduce power consumption (e.g., mitigate the battery drain) at the glasses 900 and increase a usage time (of a battery) of the glasses 900 without compromising audio quality and a user experience.

FIG. 10 illustrates a portable electronic device 1000 that corresponds to a pair of earbuds 1006 operable to offload audio processing, in accordance with some examples of the present disclosure. For example, the portable electronic device 1000 may include or correspond to the audio device 142 that is configured to support offloading of audio processing from the audio device 142 to the host device 102. FIG. 10 depicts an embodiment in which the pair of earbuds 1006 includes a first earbud 1002 and a second earbud 1004. Although earbuds are described, it should be understood that the present technology can be applied to other in-ear or over-ear audio devices.

The first earbud 1002 includes a first microphone 1010A, such as a high signal-to-noise microphone positioned to capture the voice of a wearer of the first earbud 1002, an array of one or more other microphones configured to detect ambient sounds and spatially distributed to support beamforming, illustrated as microphones 1012A, an “inner” microphone 1014A proximate to the wearer's ear canal (e.g., to assist with active noise cancelling), and a self-speech microphone 1016, such as a bone conduction microphone configured to convert sound vibrations of the wearer's ear bone or skull into an audio signal. The first earbud also includes a speaker 1008A and an integrated circuit 300A.

The second earbud 1004 can be configured in a substantially similar manner as the first earbud 1002. In some implementations, the first earbud 1002 is also configured to receive one or more audio signals generated by one or more microphones of the second earbud 1004, such as via wireless transmission between the earbuds 1002, 1004, or via wired transmission in implementations in which the earbuds 1002, 1004 are coupled via a transmission line.

In a particular example, the integrated circuit 300 of the glasses 900 is operable to bypass or deactivate at least a portion of the audio component 320 and to send an indicator, such as the indicator 186, or a request to a host request for the host device to perform one or more audio processing operations associated with the bypassed or deactivated portion of the audio component 320. Additionally, the glasses 900 is operable to obtain audio data representing sound captured by the microphone(s) 906, and to send the audio data or processed audio data (e.g., the microphone audio data 174 or the processed microphone audio data 168) to the host device. For example, the audio data may be provided to the integrated circuit 300 (having at least the portion of the audio component 320 bypassed or deactivated) prior to sending the audio data or the processed audio data to the host device. Offloading the one or more audio processing operations to the host device enables the glasses 900 to reduce power consumption (e.g., mitigate the battery drain) at the glasses 900 and increase a usage time (of a battery) of the glasses 900 without compromising audio quality and a user experience.

In FIG. 10, components of the integrated circuit 300, including the audio component 320, are integrated in the earbuds 1002, 1004. Although each earbud 1002 and 1004 is described as including a respective integrated circuit 300, in other embodiments, only one of the earbuds 1002 or 1004 includes a respective integrated circuit 300 for the portable electronic device 1000.

In a particular example, the integrated circuit 300 of the portable electronic device 1000 is operable to bypass or deactivate at least a portion of the audio component 320 and to send an indicator, such as the indicator 186, or a request to a host request for the host device to perform one or more audio processing operations associated with the bypassed or deactivated portion of the audio component 320. Additionally, the portable electronic device 1000 is operable to obtain audio data representing sound captured by the microphone(s) 1010, 1012, 1014, and/or 1016, and to send the audio data or processed audio data (e.g., the microphone audio data 174 or the processed microphone audio data 168) to the host device. For example, the audio data may be provided to the integrated circuit 300 (having at least the portion of the audio component 320 bypassed or deactivated) prior to sending the audio data or the processed audio data to the host device. Offloading the one or more audio processing operations to the host device enables the portable electronic device 1000 to reduce power consumption (e.g., mitigate the battery drain) at the portable electronic device 1000 and increase a usage time (of a battery) of the portable electronic device 1000 without compromising audio quality and a user experience.

FIG. 11 illustrates a hearing aid device 1100 operable to offload audio processing, in accordance with some examples of the present disclosure. For example, the hearing aid device 1100 may include or correspond to the audio device 142 that is configured to support offloading of audio processing from the audio device 142 to the host device 102. In FIG. 11, the hearing aid device 1100 includes a housing 1110 including an over-ear portion 1114 configured to be worn over the ear of a user. An earpiece 1112 is coupled to the housing 1110 and includes one or more speakers 1108. In some embodiments, one or more microphones 1106 are disposed on the housing 1110. In FIG. 11, components of the integrated circuit 300, e.g., the audio component 320, are integrated in the hearing aid device 1100.

In a particular example, the integrated circuit 300 of the hearing aid device 1100 is operable to bypass or deactivate at least a portion of the audio component 320 and to send an indicator, such as the indicator 186, or a request to a host request for the host device to perform one or more audio processing operations associated with the bypassed or deactivated portion of the audio component 320. Additionally, the hearing aid device 1100 is operable to obtain audio data representing sound captured by the microphone(s) 1106, and to send the audio data or processed audio data (e.g., the microphone audio data 174 or the processed microphone audio data 168) to the host device. For example, the audio data may be provided to the integrated circuit 300 (having at least the portion of the audio component 320 bypassed or deactivated) prior to sending the audio data or the processed audio data to the host device. Offloading the one or more audio processing operations to the host device enables the hearing aid device 1100 to reduce power consumption (e.g., mitigate the battery drain) at the hearing aid device 1100 and increase a usage time (of a battery) of the hearing aid device 1100 without compromising audio quality and a user experience.

FIG. 12 is a diagram of an example of a vehicle 1200 operable to support offloading audio processing, in accordance with some examples of the present disclosure. For example, the vehicle 1200 may include or correspond to the host device 102 that is configured to support offloading of audio processing from the audio device 142 to the host device 102. The vehicle 1200 may include or correspond to a car. The vehicle 1200 includes a camera 1202 (e.g., an image sensor), a display 1204 (e.g., a display screen), a microphone 1206, one or more speakers 1208, and the integrated circuit 300. Components of the integrated circuit 300, including the audio component 320, are integrated in the vehicle 1200 and are illustrated using dashed lines to indicate internal components that are not generally visible to a user of the vehicle 1200.

In a particular example, the integrated circuit 300 of the vehicle 1200 is operable to receive a request or an indicator (e.g., the indicator 186) from an audio device and to activate at least a portion of the audio component 320 to perform one or more audio processing operations offloaded from the audio device to the mobile device 400. The integrated circuit 300 of the vehicle 1200 is operable to receive audio data, such as the microphone audio data 174 or the processed microphone audio data 168, from the audio device and perform the one or more audio processing operations using the activated portion of the audio component 320 on the received audio data. Performing the one or more audio processing operations offloaded from the audio device to the vehicle 1200 enables dynamic offloading of the one or more audio processing operations based on real-time characteristics, such as power characteristics or inputs.

The embodiments of the systems or devices as described with reference to FIGS. 4-12 are described, respectively, as including a display, a microphone, a speaker, a camera, or a combination thereof. It is noted that in other embodiments of the systems or devices of FIGS. 4-12, one or more of the systems or devices of FIGS. 4-12 may not include the display, the microphone, the speaker, the camera, or a combination thereof. Additionally, or alternatively, one or more of the systems or devices of FIGS. 4-12 may include an additional component. For example, the additional component may include a modem or a wireless transceiver.

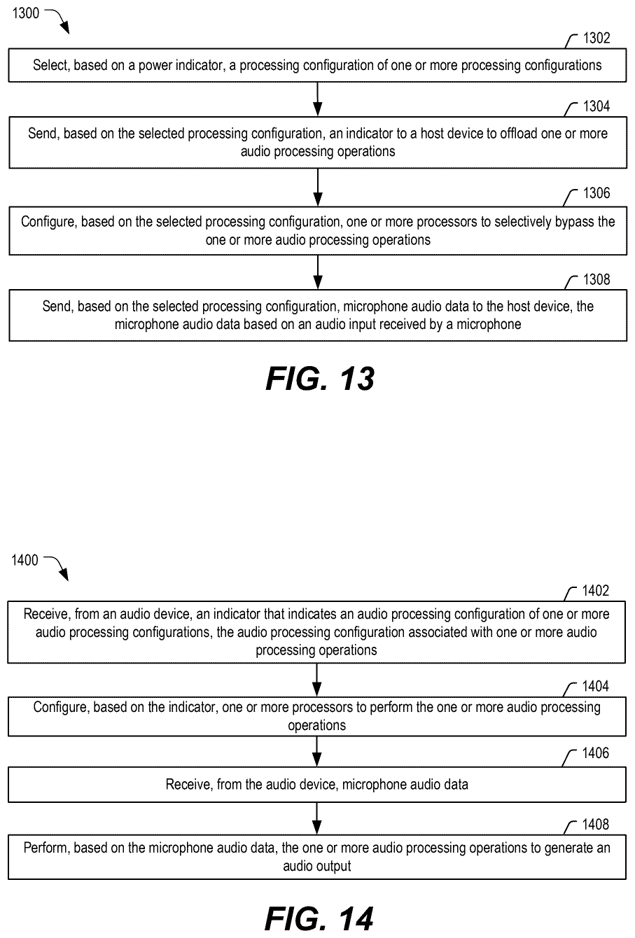

FIG. 13 is a diagram of an example of a method 1300 of operating an audio device, in accordance with some aspects of the present disclosure. In a particular aspect, one or more operations of the method 1300 are performed by the system 100, the audio device 142, the processor 148, an integrated circuit 300, a processor 308, or a combination thereof. In some embodiments, the audio device 142 is a wearable electronic device, an earbud, a hearing aid device, a mixed reality or augmented reality glasses device, a headset, a virtual reality headset, a mixed reality headset, or an augmented reality headset.

In some embodiments, the method 1300 includes, at block 1302, selecting, based on a power indicator, a processing configuration of one or more processing configurations. The power indicator may include or correspond to and the power indicator 154. The one or more audio processing configurations and the audio processing configuration include or correspond to the processing configuration data 130, 170, 330, and the processing configuration 172, respectively.

In some embodiments, the method 1300 includes obtaining the power indicator. The power indicator may indicate a power level of a battery, a charging status of the battery, or a combination thereof. For example, the battery may include or correspond to the battery 150. Additionally, or alternatively, the method 1300 can include receiving, from a sensor coupled to a battery, the power indicator based on a state associated with the battery. The sensor may include or correspond to the power sensor 152. The state associated with the battery may indicate a charged state, a charging state, or a low power state, as illustrative, non-limiting examples.

At block 1304, the method 1300 also includes, based on the selected processing configuration, sending an indicator to a host device to offload one or more audio processing operations. The indicator and the host device may include or correspond to the indicator 186 and the host device 102, respectively. In some embodiments, the host device is a mobile phone, a desktop computer, a tablet computer device, a voice-controlled speaker system, or a vehicle. The one or more audio processing operations may include ECNS operations, EC operations, NS operations, PP chain operations (e.g., a pre-processing operation, a post-processing operation, or both), or a combination thereof. In some implementations, the indicator indicates to offload the ECNS processing operations of the one or more audio processing operations to a neural processing unit, such as an ENPU, of the host device. The neural processing unit of the host device may include or correspond to the neural processing unit 129.

At block 1306, the method 1300 further includes, based on the selected processing configuration, configuring one or more processors to selectively bypass the one or more audio processing operations. The one or more processors may include or correspond to the processor 108 or 308. In some embodiments, to selectively bypass the one or more audio processing operations, the method 1300 deactivates a noise reducer, an echo cancellation unit (e.g., an echo canceller), a noise suppression unit (e.g., a noise suppressor), a pre-processing unit, a post-processing unit, or a combination thereof.

At block 1308, the method 1300 includes, based on the selected processing configuration, sending, to the host device, microphone audio data based on an audio input received by a microphone. For example, the audio input and the microphone may include or correspond to the audio input 190 and the microphone 144. In some implementations, the microphone audio data may include or correspond to the microphone audio data 174 or the processed microphone audio data 168.

In some embodiments, the method 1300 includes receiving a first input that indicates, for the processing configuration, a threshold power level, the one or more audio processing operations, or a combination thereof. The first input and the threshold power level may include or correspond to the input 140 and the threshold 171. In some examples, the method 1300 includes performing a comparison based on the power indicator and one or more thresholds, and the processing configuration is selected based on a result of the comparison. To illustrate, the power indicator can indicate a power level, and the one or more audio processing operations can be selected based on the power level being less than or equal to a first threshold of the one or more thresholds. For example, the one or more audio processing operations selected to be bypassed may include ECNS processing operations, EC processing operations, NS processing operations, PP chain processing operations, or a combination thereof. As another example, the one or more audio processing operations that are selected to be bypassed include: the ECNS processing operations and the PP chain processing operations (e.g., the pre-processing operations, the post-processing operations, or both).

In some embodiments, the method 1300 includes, after the one or more audio processing operations are offloaded to the host device, receiving, from the host device, a second indicator to perform the one or more audio processing operations. To illustrate, the second indicator may indicate that the host device will stop performing the one or more audio processing operations that were offloaded to the host device. The second indicator may include or correspond to the second indicator 188. In some examples, based on the second indicator, the method 1300 includes configuring the one or more processors to perform the one or more audio processing operations, and performing the one or more audio processing operations on the audio input to generate processed microphone audio data. For example, the audio input and the processed microphone audio data may include or correspond to the audio input 190 and the processed microphone audio data 168. The method 1300 may also include sending the processed microphone audio data to the host device.

In some embodiments, the method 1300 includes receiving a second input that indicates to offload, to the host device, an EC operation, a noise suppression operation, and a PP chain operation (e.g., a pre-processing operation, a post-processing operation, or both). The second input may include or correspond to the input 140. In response to the second input, the method 1300 may include sending another indicator to the host device to offload the EC operation, the noise suppression operation, the PP chain operation (e.g., the pre-processing operation, the post-processing operation, or both). The other indicator may include or correspond to the indicator 186.

In some embodiments, the method 1300 includes receiving, from the host device, a host power indicator that indicates a power level of a battery of the host device, a charging status of the battery of the host device, or a combination thereof. The host power indicator and the battery of the host device may include or correspond to the host power indicator 114 and the battery 110, respectively. In some examples, the processing configuration is further selected based on the host power indicator.

In some embodiments, the method 1300 includes enabling, via a wireless communication transceiver, communication with the host device. For example, the wireless communication transceiver may include or correspond to the wireless interface 158. In some examples, the method 1300 includes establishing a communication session with the host device via the wireless communication transceiver. The communication session may be associated with a personal area network, such as an XPAN, as an illustrative, non-limiting example. The personal area network may include or support a peer-to-peer link with the host device, and a WiFi link with the host device via a network node. The network node may include or correspond to the network node 180.

In some embodiments, the method 1300 includes communicating, via a modem, with the host device. The modem may include or correspond to the wireless interface 158. For example, the modem may be configured to send processed microphone audio data, such as the processed microphone audio data 168, generated based on the one or more audio processing operations performed on the microphone audio data, such as the microphone audio data 174.

In some embodiments, the method 1300 includes receiving, via a microphone, microphone audio data based on an audio input received by the microphone. For example, the microphone and the microphone audio data may include or correspond to the microphone 144 and the microphone audio data 174. The microphone may be configured to receive an audio input, such as the audio input 190, and generate the microphone audio data 174. Additionally, or alternatively, the method 1300 includes receiving audio output data, and providing the audio output data to a speaker. The audio output data and the speaker may include or correspond to the output audio data 175 and the speaker 145, respectively.

FIG. 14 is a diagram of an example of a method 1400 of operating a host device, in accordance with some aspects of the present disclosure. In a particular aspect, one or more operations of the method 1400 are performed by the system 100, the host device 102, the processor 108, the integrated circuit 300, the processor 308, or a combination thereof. In some embodiments, the host device 102 includes the mobile device 400, a desktop computer, a tablet computer device, a voice-controlled speaker system, or the vehicle 1200.

In some embodiments, the method 1400 includes, at block 1402, receiving, from an audio device, an indicator that indicates an audio processing configuration of one or more audio processing configurations. The audio device and the indicator may include or correspond to the audio device 142 and the indicator 186, respectively. In some embodiments, the audio device is a wearable electronic device, an earbud, a hearing aid device, a mixed reality or augmented reality glasses device, a headset, a virtual reality headset, a mixed reality headset, or an augmented reality headset. The one or more audio processing configurations and the audio processing configuration include or correspond to the processing configuration data 130, 170, 330, and the processing configuration 172, respectively.

The audio processing configuration is associated with one or more audio processing operations. The one or more audio processing operations include ECNS processing operations, EC processing operations, NS processing operations, PP chain operations (e.g., pre-processing operations, post-processing operations, or both), or a combination thereof. The PP chain operations may include performing a voice enhancement operation, monitoring for an adverse event, filtering, performing a gain operation, or a combination thereof, as illustrative, non-limiting examples.

At block 1404, the method 1400 also includes configuring, based on the indicator, one or more processors to perform the one or more audio processing operations. The one or more processors may include or correspond to the processor 108, the neural processing unit 129 (e.g., an ENPU), the processor 308, or the audio component 320.

At block 1406, the method 1400 further includes receiving, from the audio device, microphone audio data. The microphone audio data may include or correspond to the microphone audio data 174 or the processed microphone audio data 168.

At block 1408, the method 1400 includes performing, based on the microphone audio data, the one or more audio processing operations to generate an audio output. The audio output may include or correspond to the audio output 128.

In some embodiments, the method 1400 includes sending, via a modem, the audio output generated based on the one or more audio processing operations performed on the microphone audio data. The modem may include or correspond to the wireless interface 118.

In some embodiments, the method 1400 includes obtaining a power indicator that indicates a power level of a battery, a charging status of the battery, or a combination thereof. The power indicator and the battery may include or correspond to the host power indicator 114 and the battery 110, respectively. The method 1400 may include performing a comparison based on the power indicator and one or more thresholds, such as the threshold 132. In some examples, the method 1400 includes generating, based on a result of the comparison, a second indicator that indicates for the audio device to perform the one or more audio processing operations. The second indicator may include or correspond to the second indicator 188. In some such examples, the method 1400 can include sending the second indicator to the audio device, and configuring the one or more processors to selectively bypass the one or more audio processing operations. To selectively bypass the one or more audio processing operations, the method 1400 can include deactivating one or more audio components. The one or more audio components may include or correspond to a media format converter, a synchronizer, a noise reducer, an ECNS engine 120, an EC engine 122 or 322, and NS engine 124 or 324, a PP chain 126 or 326, a pre-processing unit, a post-processing unit, an encoder, a decoder, or a combination thereof.

In some embodiments, the method 1400 includes sending, to the audio device, the power indicator. For example, the power indicator can be sent prior to receipt of the indicator. In some embodiments, the method 1400 may include generating the power indicator based on the state associated with the battery, such as a charged state, a charging state, or a low power state.

In some embodiments, the method 1400 includes receiving, from the audio device, another indicator to offload an EC operation, a noise suppression operation, and a PP chain operation (e.g., a pre-processing operation or a post-processing operation). The other indicator may be sent by the audio device in response to an input received by the audio device. The input may include or correspond to the input 140. In some examples, the input indicates or requests to offload, from the audio device, the EC operation, the noise suppression operation, the pre-processing operation, and the post-processing operation.

In some embodiments, the method 1400 includes establishing a communication session with the audio device. For example, the communication session may be associated with a personal area network that includes or is configured to communicate via a peer-to-peer link with the audio device, and a WiFi link with the audio device via a network node. The communication session, e.g., the peer-to-peer link, the WiFi link, or both, may be established prior to the audio device offloading the one or more audio processing operations.

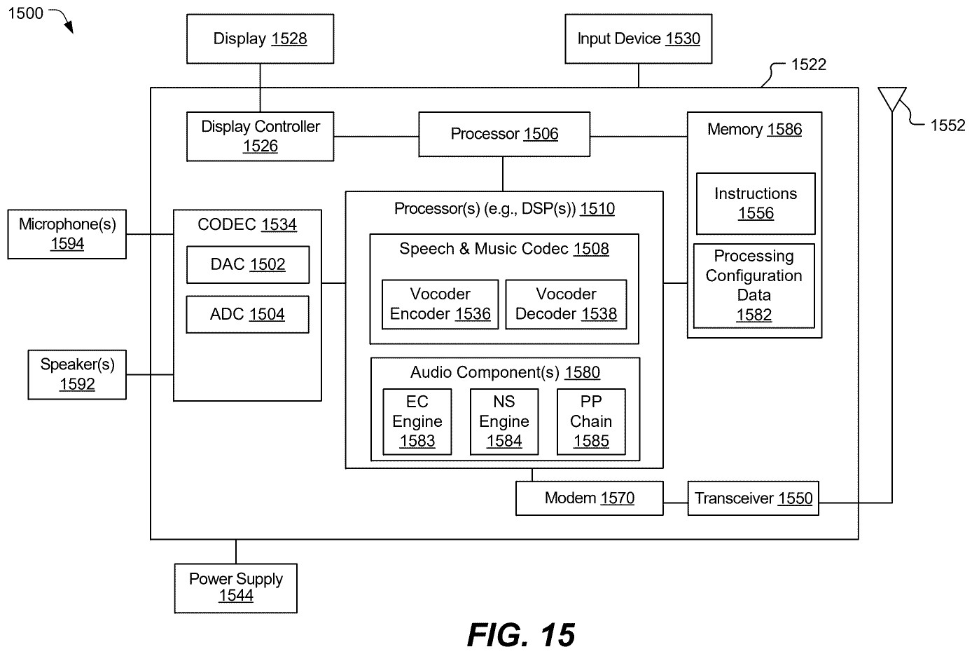

The method 1300 of FIG. 13 or the method 1400 of FIG. 14 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 1300 of FIG. 13 may be performed by a processor that executes instructions, such as described with reference to FIG. 15. As another example, the method 1400 of FIG. 14 may be performed by a processor that executes instructions, such as described with reference to FIG. 15.

It is noted that one or more blocks (or operations) described with reference to FIG. 13 or 14 may be combined with one or more blocks (or operations) described with reference to another of the figures. For example, one or more blocks (or operations) of FIG. 13 may be combined with one or more blocks (or operations) of FIG. 14. As another example, one or more blocks associated with FIG. 13 or 14 may be combined with one or more blocks (or operations) associated with FIGS. 1-12. For example, one or more blocks of FIG. 13 or 14 may be combined with one or more operations described with reference to FIG. 2. Additionally, or alternatively, one or more operations described above with reference to FIGS. 1-14 may be combined with one or more operations described with reference to FIG. 15.

Referring to FIG. 15, FIG. 15 is a block diagram of an illustrative example of a device 1500 that is operable to support offloading audio processing, in accordance with one or more aspects of the present disclosure. In various implementations, the device 1500 may have more or fewer components than illustrated in FIG. 15. In an illustrative implementation, the device 1500 may correspond to the host device 102 or the audio device 142. In an illustrative implementation, the device 1500 may perform one or more operations described with reference to FIGS. 1-14.

In a particular implementation, the device 1500 includes a processor 1506 (e.g., a central processing unit (CPU)). The device 1500 may include one or more additional processors 1510 (e.g., one or more DSPs). In a particular aspect, the processor 108 of FIG. 1 or the processor 308 of FIG. 3 corresponds to the processor 1506, the processors 1510, or a combination thereof. In some embodiments, the processor 1506 or 1510 includes a neural processing unit, such as the neural processing unit 129 of FIG. 1. The processors 1510 may include a speech and music coder-decoder (CODEC) 1508 that includes a voice coder (“vocoder”) encoder 1536, a vocoder decoder 1538, one or more audio component(s) 1580, or a combination thereof. In some embodiments, the audio component 1580, or a portion thereof, may be included in the CODEC 1508 (e.g., the vocoder 1536). The audio component 1580 may include or correspond to the audio component 320. The audio component 1580 includes an EC engine 1583, an NS engine 1584, a PP chain 1585, an ECNS engine, a media format converter, a synchronizer, or a combination thereof. The EC engine 1583 may include or correspond to the ECNS engine 120 or the EC engine 122, 162, or 322. The NS engine 1584 may include or correspond to the ECNS engine 120 or the NS engine 124, 164, or 324. The PP chain 1585 may include or correspond to the PP chain 126, 166, or 326.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, central processing units (CPUs), digital signal processors (DSPs), neural processing units (NPU), graphics processing units (GPUs), field programmable gate arrays (FPGAs), microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor's ability to perform particular types of operations. For example, the logic gates, local memory circuits, and the interconnects therebetween of a GPU are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnect sets of transistors and memory elements) that can be configured (often on the fly) to perform customizable logic functions.

The device 1500 may include a memory 1586 and a CODEC 1534. The memory 1586 may include or correspond to the memory 106 or 146 of FIG. 1 or the memory 306 of FIG. 3. The memory 1586 may include instructions 1556, that are executable by the one or more additional processors 1510 (or the processor 1506) to implement the functionality described with reference to the audio component 1580, or both. The instructions 1556 may include or correspond to the instructions 109 or 149 of FIG. 1. The memory 1586 also may include processing configuration data 1582. The processing configuration data 1582 may include or correspond to the processing configuration data 130 or 170 of FIG. 1 or the processing configuration data 330 of FIG. 3. The device 1500 may include a modem 1570 coupled, via a transceiver 1550, to an antenna 1552. The modem 1570, the transceiver 1550, or a combination thereof, may include or correspond to the wireless interface 118 or 158.

The device 1500 may include a display 1528 coupled to a display controller 1526. One or more speakers 1592, one or more microphone(s) 1594, or both, may be coupled to the CODEC 1534. The microphone(s) 1594 may include or correspond to the microphone 144 or a microphone of one or more of the devices of FIGS. 4-12. The CODEC 1534 may include a digital-to-analog converter (DAC) 1502, an analog-to-digital converter (ADC) 1504, or both. In a particular implementation, the CODEC 1534 may receive analog signals from the microphone(s) 1594, convert the analog signals to digital signals using the analog-to-digital converter 1504, and provide the digital signals to the speech and music codec 1508, the audio component 1580, or a combination thereof. The speech and music codec 1508, the audio component 1580, or a combination thereof, may process the digital signals. In a particular implementation, the speech and music codec 1508 may provide digital signals to the CODEC 1534. The CODEC 1534 may convert the digital signals to analog signals using the digital-to-analog converter 1502 and may provide the analog signals to the speaker 1592. The speaker 1592 may include or correspond to the speaker 145 or a speaker of one or more of the devices of FIGS. 4-12.

In a particular implementation, the device 1500 may be included in a system-in-package or system-on-chip device 1522. In a particular implementation, the memory 1586, the processor 1506, the processors 1510, the display controller 1526, the CODEC 1534, and the modem 1570 are included in the system-in-package or system-on-chip device 1522. In a particular implementation, an input device 1530 and a power supply 1544 are coupled to the system-in-package or the system-on-chip device 1522. For example, the power supply 1544 may include or correspond to the battery 110 or 150. In some examples, the input device 1530 may include or be associated with the display 1528. Moreover, in a particular implementation, as illustrated in FIG. 15, the display 1528, the input device 1530, the speaker(s) 1592, the microphone(s) 1594, the antenna 1552, and the power supply 1544 are external to the system-in-package or the system-on-chip device 1522. In a particular implementation, each of the display 1528, the input device 1530, the speaker(s) 1592, the microphone(s) 1594, the antenna 1552, and the power supply 1544 may be coupled to a component of the system-in-package or the system-on-chip device 1522, such as an interface or a controller.

The device 1500 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for selecting, based on a power indicator, a processing configuration of one or more processing configurations. For example, the means for selecting the processing configuration can include the system 100, the audio device 142, the memory 146, the processor 148, the integrated circuit 300, the processor 308, the audio component 320, the headset device 500, the wearable electronic device 600, the voice-controlled speaker system 700, the headset 800, the glasses 900, the portable electronic device 1000, the hearing aid device 1100, the device 1500, the processor 1506, the CODEC 1508, the processor(s) 1510, the system-in-package or the system-on-chip device 1522, the audio component 1580, the memory 1586, other circuitry configured to select the processing configuration, or a combination thereof.

The apparatus also includes means for sending, based on the selected processing configuration, an indicator to a host device to offload one or more audio processing operations. For example, the means for sending the indicator can include the system 100, the audio device 142, the processor 148, the wireless interface 158, the integrated circuit 300, the processor 308, the audio component 320, the output interface 305, the headset device 500, the wearable electronic device 600, the voice-controlled speaker system 700, the headset 800, the glasses 900, the portable electronic device 1000, the hearing aid device 1100, the device 1500, the processor 1506, the processor(s) 1510, the system-in-package or the system-on-chip device 1522, the transceiver 1550, the antenna 1552, the modem 1570, the audio component 1580, other circuitry configured to send the indicator, or a combination thereof.

The apparatus further includes means for configuring, based on the selected processing configuration, one or more processors to selectively bypass the one or more audio processing operations. For example, the means for configuring the one or more processors can include the system 100, the audio device 142, the memory 146, the processor 148, the integrated circuit 300, the processor 308, the audio component 320, the headset device 500, the wearable electronic device 600, the voice-controlled speaker system 700, the headset 800, the glasses 900, the portable electronic device 1000, the hearing aid device 1100, the device 1500, the processor 1506, the CODEC 1508, the processor(s) 1510, the system-in-package or the system-on-chip device 1522, the audio component 1580, the memory 1586, other circuitry configured to configure the one or more processors, or a combination thereof.

The apparatus includes means for sending, based on the selected processing configuration, microphone audio data to the host device. For example, the means for sending the microphone audio data can include the system 100, the audio device 142, the processor 148, the wireless interface 158, the integrated circuit 300, the processor 308, the audio component 320, the output interface 305, the headset device 500, the wearable electronic device 600, the voice-controlled speaker system 700, the headset 800, the glasses 900, the portable electronic device 1000, the hearing aid device 1100, the device 1500, the processor 1506, the processor(s) 1510, the system-in-package or the system-on-chip device 1522, the transceiver 1550, the antenna 1552, the modem 1570, the audio component 1580, other circuitry configured to send the microphone audio data, or a combination thereof. The microphone audio data is based on an audio input received by a microphone.

In conjunction with the described implementations, an apparatus includes means for receiving, from an audio device, an indicator that indicates an audio processing configuration of one or more audio processing configurations. For example, the means for receiving the indicator can include the system 100, the host device 102, the memory 106, the processor 108, the wireless interface 118, the integrated circuit 300, the input interface 304, the processor 308, the audio component 320, the mobile device 400, the vehicle 1200, the device 1500, the processor 1506, the processor(s) 1510, the system-in-package or the system-on-chip device 1522, the transceiver 1550, the modem 1570, the audio component 1580, the memory 1586, other circuitry configured to receive the indicator, or a combination thereof. The audio processing configuration is associated with one or more audio processing operations.

The apparatus also includes means for configuring, based on the indicator, the apparatus to perform the one or more audio processing operations. For example, the means for configuring can include the system 100, the host device 102, the processor 108, the integrated circuit 300, the processor 308, the audio component 320, the mobile device 400, the vehicle 1200, the device 1500, the processor 1506, the CODEC 1508, the processor(s) 1510, the system-in-package or the system-on-chip device 1522, the audio component 1580, the memory 1586, other circuitry configured to configuring the apparatus, or a combination thereof.

The apparatus also includes means for receiving, from the audio device, microphone audio data. For example, the means for receiving the microphone audio data can include the system 100, the host device 102, the memory 106, the processor 108, the wireless interface 118, the integrated circuit 300, the input interface 304, the processor 308, the audio component 320, the mobile device 400, the vehicle 1200, the device 1500, the processor 1506, the processor(s) 1510, the system-in-package or the system-on-chip device 1522, the transceiver 1550, the modem 1570, the audio component 1580, the memory 1586, other circuitry configured to receive the microphone audio data, or a combination thereof.

The apparatus also includes means for performing, based on the microphone audio data, the one or more audio processing operations to generate an audio output. For example, the means for performing can include the system 100, the host device 102, the processor 108, the ECNS engine 120, the EC engine 122, the NS engine, the PP chain 126, the neural processing unit 129, the integrated circuit 300, the processor 308, the audio component 320, the mobile device 400, the vehicle 1200, the device 1500, the processor 1506, the CODEC 1508, the processor(s) 1510, the system-in-package or the system-on-chip device 1522, the vocoder encoder 1536, the audio component 1580, the EC engine 1883, the NS engine 1884, the PP chain 1885, the memory 1586, other circuitry configured to perform the one or more audio processing operations, or a combination thereof.

In some implementations, a non-transitory computer-readable medium (e.g., a computer-readable storage device, such as the memory 1586) includes instructions (e.g., the instructions 1556) that, when executed by one or more processors (e.g., the one or more processors 1510 or the processor 1506), cause the one or more processors to select, based on a power indicator, a processing configuration of one or more processing configurations. The instructions further cause the one or more processors to, based on the selected processing configuration: send an indicator to a host device to offload one or more audio processing operations, configure the one or more processors to selectively bypass the one or more audio processing operations, and send, to the host device, microphone audio data based on an audio input received by a microphone (e.g., the microphone 1594).

In some implementations, a non-transitory computer-readable medium (e.g., a computer-readable storage device, such as the memory 1586) includes instructions (e.g., the instructions 1556) that, when executed by one or more processors (e.g., the one or more processors 1510 or the processor 1506), cause the one or more processors to receive, from an audio device, an indicator that indicates an audio processing configuration of one or more audio processing configurations. The audio processing configuration is associated with one or more audio processing operations. The instructions further cause the one or more processors to, based on the indicator, configure the one or more processors to perform the one or more audio processing operations. The instructions further cause the one or more processors to receive, from the audio device, microphone audio data. The instructions further cause the one or more processors to perform, based on the microphone audio data, the one or more audio processing operations to generate an audio output.

Particular aspects of the disclosure are described below in sets of interrelated Examples:

According to Example 1, a device includes a memory configured to store processing configuration data that indicates one or more processing configurations; and one or more processors coupled to the memory, the one or more processors configured to select, based on a power indicator, a processing configuration of the one or more processing configurations; and, based on the selected processing configuration: send an indicator to a host device to offload one or more audio processing operations; configure the one or more processors to selectively bypass the one or more audio processing operations; and send, to the host device, microphone audio data based on an audio input received by a microphone.

Example 2 includes the device of Example 1, where the one or more audio processing operations include echo cancellation noise suppression (ECNS) operations, a pre-processing operation, a post-processing operation, or a combination thereof.

Example 3 includes the device of Example 1 or Example 2, where the one or more processors are configured to obtain the power indicator, and the power indicator indicates a power level of a battery of the device, a charging status of the battery of the device, or a combination thereof.

Example 4 includes the device of any one of Examples 1-3, where the one or more processors are configured to receive a first input that indicates, for the processing configuration, a threshold power level, the one or more audio processing operations, or a combination thereof.

Example 5 includes the device of any one of Examples 1-4, where the one or more processors are configured to perform a comparison based on the power indicator and one or more thresholds, and where the processing configuration is selected based on a result of the comparison.

Example 6 includes the device of Example 5, where the power indicator indicates a power level; and, based on the power level being less than or equal to a first threshold of the one or more thresholds, the one or more audio processing operations that are selected to be bypassed include echo cancellation noise suppression (ECNS) processing operations.

Example 7 includes the device of Example 6, where the indicator indicates to offload the ECNS processing operations of the one or more audio processing operations to an embedded neuron processing unit (ENPU) of the host device.

Example 8 includes the device of claim 6-7, where, based on the power level being less than or equal to the first threshold of the one or more thresholds, the one or more audio processing operations that are selected to be bypassed include: the ECNS processing operations; and pre-processing operations, post-processing operations, or a combination thereof.

Example 9 includes the device of any one of Examples 1-8, where, after the one or more audio processing operations are offloaded to the host device, the one or more processors are configured to: receive, from the host device, a second indicator to perform the one or more audio processing operations; configure the one or more processors to perform the one or more audio processing operations; perform the one or more audio processing operations on the audio input to generate processed microphone audio data; and send the processed microphone audio data to the host device.

Example 10 includes the device of any one of Examples 1-9, where the one or more processors are configured to receive a second input that indicates to offload, to the host device, an echo cancellation (EC) operation, a noise suppression operation, a pre-processing operation, and a post-processing operation.

Example 11 includes the device of Example 10, where the one or more processors are configured to, in response to the second input, send another indicator to the host device to offload the EC operation, the noise suppression operation, the pre-processing operation, and the post-processing operation.

Example 12 includes the device of any one of Examples 1-11, where the one or more processors are configured to receive, from the host device, a host power indicator that indicates a power level of a battery of the host device, a charging status of the battery of the host device, or a combination thereof.

Example 13 includes the device of Example 12, where the processing configuration is further selected based on the host power indicator.

Example 14 includes the device of any one of Examples 1-13, where, to selectively bypass the one or more audio processing operations, the one or more processors are configured to deactivate a noise reducer, a pre-processing unit, a post-processing unit, or a combination thereof.

Example 15 includes the device of any one of Examples 1-14, and further includes a battery; and a sensor coupled to the battery and configured to generate the power indicator based on a state associated with the battery.

Example 16 includes the device of any one of Examples 1-15, and further includes a wireless communication transceiver configured to enable communication between the device and the host device.

Example 17 includes the device of Example 16, where the one or more processors are configured to establish a communication session with the host device via the wireless communication transceiver.

Example 18 includes the device of Example 17, where the communication session is associated with a personal area network including: a peer-to-peer link between the device and the host device; and a wireless fidelity (WiFi) link between the device and the host device via a network node.

Example 19 includes the device of any one of Examples 1-18, and further includes a microphone configured to receive the audio input and generate the microphone audio data based on the audio input.

Example 20 includes the device of any one of Examples 1-19, and further includes a speaker configured to output audio based on audio output data, and where the one or more processors are configured to obtain the audio output data and provide the audio output data to the speaker.

Example 21 includes the device of any one of Examples 1-20, where the device is a wearable electronic device, an earbud, a hearing aid device, a mixed reality or augmented reality glasses device, a headset, a virtual reality headset, a mixed reality headset, or an augmented reality headset.

Example 22 includes the device of any one of Examples 1-21, where the host device includes a modem configured to send processed microphone audio data generated based on the one or more audio processing operations performed on the microphone audio data.

Example 23 includes the device of any one of Examples 1-22, where the host device is a mobile phone, a desktop computer, a tablet computer device, a voice-controlled speaker system, or a vehicle.

According to Example 24, a method of operating a processor of an audio device, the method includes selecting, based on a power indicator, a processing configuration of one or more processing configurations; and, based on the selected processing configuration: sending an indicator to a host device to offload one or more audio processing operations; configuring the one or more processors to selectively bypass the one or more audio processing operations; and sending, to the host device, microphone audio data based on an audio input received by a microphone.

Example 25 includes the method of Example 24, where the one or more audio processing operations include echo cancellation noise suppression (ECNS) operations, a pre-processing operation, a post-processing operation, or a combination thereof.

Example 26 includes the method of Example 24 or Example 25, and further includes obtaining the power indicator, and the power indicator indicates a power level of a battery of the device, a charging status of the battery of the device, or a combination thereof.

Example 27 includes the method of any one of Examples 24-26, and further includes receiving a first input that indicates, for the processing configuration, a threshold power level, the one or more audio processing operations, or a combination thereof.

Example 28 includes the method of any one of Examples 24-27, and further includes performing a comparison based on the power indicator and one or more thresholds, and where the processing configuration is selected based on a result of the comparison.

Example 29 includes the method of Example 28, where the power indicator indicates a power level; and, based on the power level being less than or equal to a first threshold of the one or more thresholds, the one or more audio processing operations that are selected to be bypassed include echo cancellation noise suppression (ECNS) processing operations.

Example 30 includes the method of Example 29, where the indicator indicates to offload the ECNS processing operations of the one or more audio processing operations to an embedded neuron processing unit (ENPU) of the host device.

Example 31 includes the method of any one of Examples 29-30, where, based on the power level being less than or equal to the first threshold of the one or more thresholds, the one or more audio processing operations that are selected to be bypassed include: the ECNS processing operations; and pre-processing operations, post-processing operations, or a combination thereof.

Example 32 includes the method of any one of Examples 24-31, and further includes, after the one or more audio processing operations are offloaded to the host device: receiving, from the host device, a second indicator to perform the one or more audio processing operations; configuring the one or more processors to perform the one or more audio processing operations; performing the one or more audio processing operations on the audio input to generate processed microphone audio data; and sending the processed microphone audio data to the host device.

Example 33 includes the method of any one of Examples 24-32, and further includes receiving a second input that indicates to offload, to the host device, an echo cancellation (EC) operation, a noise suppression operation, a pre-processing operation, and a post-processing operation.

Example 34 includes the method of Example 33, and further includes, in response to the second input, sending another indicator to the host device to offload the EC operation, the noise suppression operation, the pre-processing operation, and the post-processing operation.

Example 35 includes the method of any one of Examples 24-34, and further includes receiving, from the host device, a host power indicator that indicates a power level of a battery of the host device, a charging status of the battery of the host device, or a combination thereof.

Example 36 includes the method of Example 35, where the processing configuration is further selected based on the host power indicator.

Example 37 includes the method of any one of Examples 24-36, and further includes, to selectively bypass the one or more audio processing operations, deactivating a noise reducer, a pre-processing unit, a post-processing unit, or a combination thereof.

Example 38 includes the method of any one of Examples 24-37, and further includes receiving, from a sensor coupled to a battery, the power indicator based on a state associated with the battery.

Example 39 includes the method of any one of Examples 24-38, and further includes enabling, via a wireless communication transceiver, communication between the audio device and the host device.

Example 40 includes the method of Example 39, and further includes establishing a communication session with the host device via the wireless communication transceiver.

Example 41 includes the method of Example 40, where the communication session is associated with a personal area network including: a peer-to-peer link between the audio device and the host device; and a wireless fidelity (WiFi) link between the audio device and the host device via a network node.

Example 42 includes the method of any one of Examples 24-41, and further includes receiving, via a microphone, microphone audio data based on an audio input received by the microphone.

Example 43 includes the method of any one of Examples 24-42, and further includes receiving audio output data; and providing the audio output data to a speaker.

Example 44 includes the method of any one of Examples 24-43, where the audio device is a wearable electronic device, an earbud, a hearing aid device, a mixed reality or augmented reality glasses device, a headset, a virtual reality headset, a mixed reality headset, or an augmented reality headset.

Example 45 includes the method of any one of Examples 24-44, where the host device includes a modem configured to send processed microphone audio data generated based on the one or more audio processing operations performed on the microphone audio data.

Example 46 includes the method of any one of Examples 24-45, where the host device is a mobile phone, a desktop computer, a tablet computer device, a voice-controlled speaker system, or a vehicle.

According to Example 47, a non-transitory computer-readable medium storing instructions that are executable by one or more processors to cause the one or more processors to select, based on a power indicator, a processing configuration of one or more processing configurations; and based on the selected processing configuration: send an indicator to a host device to offload one or more audio processing operations; configure the one or more processors to selectively bypass the one or more audio processing operations; and send, to the host device, microphone audio data based on an audio input received by a microphone.

Example 48 includes the non-transitory computer-readable medium of Example 47, where the one or more audio processing operations include echo cancellation noise suppression (ECNS) operations, a pre-processing operation, a post-processing operation, or a combination thereof.

Example 49 includes the non-transitory computer-readable medium of Example 47 or Example 48, where the instructions are executable by the one or more processors to cause the one or more processors to obtain the power indicator, and the power indicator indicates a power level of a battery coupled to the non-transitory computer-readable medium, a charging status of the battery coupled to the non-transitory computer-readable medium, or a combination thereof.

Example 50 includes the non-transitory computer-readable medium of any one of Examples 47-49, where the instructions are executable by the one or more processors to cause the one or more processors to receive a first input that indicates, for the processing configuration, a threshold power level, the one or more audio processing operations, or a combination thereof.

Example 51 includes the non-transitory computer-readable medium of any one of Examples 47-50, where the instructions are executable by the one or more processors to cause the one or more processors to perform a comparison based on the power indicator and one or more thresholds, and where the processing configuration is selected based on a result of the comparison.

Example 52 includes the non-transitory computer-readable medium of Example 51, where the power indicator indicates a power level; and, based on the power level being less than or equal to a first threshold of the one or more thresholds, the one or more audio processing operations that are selected to be bypassed include echo cancellation noise suppression (ECNS) processing operations.

Example 53 includes the non-transitory computer-readable medium of Example 52, where the indicator indicates to offload the ECNS processing operations of the one or more audio processing operations to an embedded neuron processing unit (ENPU) of the host device.

Example 54 includes the non-transitory computer-readable medium of any one of Examples 52-53, where, based on the power level being less than or equal to the first threshold of the one or more thresholds, the one or more audio processing operations that are selected to be bypassed include: the ECNS processing operations; and pre-processing operations, post-processing operations, or a combination thereof.

Example 55 includes the non-transitory computer-readable medium of any one of Examples 47-54, where the instructions are executable by the one or more processors to cause the one or more processors to, after the one or more audio processing operations are offloaded to the host device: receive, from the host device, a second indicator to perform the one or more audio processing operations; configure the one or more processors to perform the one or more audio processing operations; perform the one or more audio processing operations on the audio input to generate processed microphone audio data; and send the processed microphone audio data to the host device.

Example 56 includes the non-transitory computer-readable medium of any one of Examples 47-55, where the instructions are executable by the one or more processors to cause the one or more processors to receive a second input that indicates to offload, to the host device, an echo cancellation (EC) operation, a noise suppression operation, a pre-processing operation, and a post-processing operation.

Example 57 includes the non-transitory computer-readable medium of Example 56, where the instructions are executable by the one or more processors to cause the one or more processors to, in response to the second input, send another indicator to the host device to offload the EC operation, the noise suppression operation, the pre-processing operation, and the post-processing operation.

Example 58 includes the non-transitory computer-readable medium of any one of Examples 47-57, where the instructions are executable by the one or more processors to cause the one or more processors to receive, from the host device, a host power indicator that indicates a power level of a battery of the host device, a charging status of the battery of the host device, or a combination thereof.

Example 59 includes the non-transitory computer-readable medium of Example 58, where the processing configuration is further selected based on the host power indicator.

Example 60 includes the non-transitory computer-readable medium of any one of Examples 47-59, where the instructions are executable by the one or more processors to cause the one or more processors to, to selectively bypass the one or more audio processing operations, deactivate a noise reducer, a pre-processing unit, a post-processing unit, or a combination thereof.

Example 61 includes the non-transitory computer-readable medium of any one of Examples 47-60, where the instructions are executable by the one or more processors to cause the one or more processors to receive, from a sensor coupled to a battery, the power indicator based on a state associated with the battery.

Example 62 includes the non-transitory computer-readable medium of any one of Examples 47-61, where the instructions are executable by the one or more processors to cause the one or more processors to enable, via a wireless communication transceiver coupled to the non-transitory computer-readable medium, communication with the host device.

Example 63 includes the non-transitory computer-readable medium of Example 62, where the instructions are executable by the one or more processors to cause the one or more processors to establish a communication session with the host device via the wireless communication transceiver.

Example 64 includes the non-transitory computer-readable medium of Example 63, where the communication session is associated with a personal area network including: a peer-to-peer link between a device that includes the non-transitory computer-readable medium and the host device; and a wireless fidelity (WiFi) link between the device and the host device via a network node.

Example 65 includes the non-transitory computer-readable medium of any one of Examples 47-64, where the instructions are executable by the one or more processors to cause the one or more processors to receive, via a microphone, microphone audio data based on an audio input received by the microphone.

Example 66 includes the non-transitory computer-readable medium of any one of Examples 47-65, where the instructions are executable by the one or more processors to cause the one or more processors to: receive audio output data; and provide the audio output data to a speaker.

Example 67 includes the non-transitory computer-readable medium of any one of Examples 47-66, where the non-transitory computer-readable medium is included in a wearable electronic device, an earbud, a hearing aid device, a mixed reality or augmented reality glasses device, a headset, a virtual reality headset, a mixed reality headset, or an augmented reality headset.

Example 68 includes the non-transitory computer-readable medium of any one of Examples 47-67, where the host device includes a modem configured to send processed microphone audio data generated based on the one or more audio processing operations performed on the microphone audio data.

Example 69 includes the non-transitory computer-readable medium of any one of Examples 47-68, where the host device is a mobile phone, a desktop computer, a tablet computer device, a voice-controlled speaker system, or a vehicle.

According to Example 70, an apparatus includes means for selecting, based on a power indicator, a processing configuration of one or more processing configurations; means for sending, based on the selected processing configuration, an indicator to a host device to offload one or more audio processing operations; means for configuring, based on the selected processing configuration, the one or more processors to selectively bypass the one or more audio processing operations; and means for sending, based on the selected processing configuration, microphone audio data to the host device, the microphone audio data based on an audio input received by a microphone.

Example 71 includes the apparatus of Example 70, where the one or more audio processing operations include echo cancellation noise suppression (ECNS) operations, a pre-processing operation, a post-processing operation, or a combination thereof.

Example 72 includes the apparatus of Example 70 or Example 71, and further includes means for obtaining the power indicator, and the power indicator indicates a power level of a battery of the apparatus, a charging status of the battery of the apparatus, or a combination thereof.

Example 73 includes the apparatus of any one of Examples 70-72, and further includes means for receiving a first input that indicates, for the processing configuration, a threshold power level, the one or more audio processing operations, or a combination thereof.

Example 74 includes the apparatus of any one of Examples 70-73, and further includes means for performing a comparison based on the power indicator and one or more thresholds, and where the processing configuration is selected based on a result of the comparison.

Example 75 includes the apparatus of Example 74, where the power indicator indicates a power level; and, based on the power level being less than or equal to a first threshold of the one or more thresholds, the one or more audio processing operations that are selected to be bypassed include echo cancellation noise suppression (ECNS) processing operations.

Example 76 includes the apparatus of Example 75, where the indicator indicates to offload the ECNS processing operations of the one or more audio processing operations to an embedded neuron processing unit (ENPU) of the host device.

Example 77 includes the apparatus of any one of Examples 75-76, where, based on the power level being less than or equal to the first threshold of the one or more thresholds, the one or more audio processing operations that are selected to be bypassed include: the ECNS processing operations; and pre-processing operations, post-processing operations, or a combination thereof.

Example 78 includes the apparatus of any one of Examples 70-77, and further includes means for receiving, from the host device after the one or more audio processing operations are offloaded to the host device, a second indicator to perform the one or more audio processing operations; means for configuring, based on the second indicator, the one or more processors to perform the one or more audio processing operations; means for performing the one or more audio processing operations on the audio input to generate processed microphone audio data; and means for sending the processed microphone audio data to the host device.

Example 79 includes the apparatus of any one of Examples 70-78, and further includes means for receiving a second input that indicates to offload, to the host device, an echo cancellation (EC) operation, a noise suppression operation, a pre-processing operation, and a post-processing operation.

Example 80 includes the apparatus of Example 79, and further includes means for sending, in response to the second input, another indicator to the host device to offload the EC operation, the noise suppression operation, the pre-processing operation, and the post-processing operation.

Example 81 includes the apparatus of any one of Examples 70-80, and further includes means for receiving, from the host device, a host power indicator that indicates a power level of a battery of the host device, a charging status of the battery of the host device, or a combination thereof.

Example 82 includes the apparatus of Example 81, where the processing configuration is further selected based on the host power indicator.

Example 83 includes the apparatus of any one of Examples 70-82, and further includes means for deactivating a noise reducer, a pre-processing unit, a post-processing unit, or a combination thereof.

Example 84 includes the apparatus of any one of Examples 70-83, and further includes means for receiving, from a sensor coupled to a battery, the power indicator based on a state associated with the battery.

Example 85 includes the apparatus of any one of Examples 70-84, and further includes means for enabling, via a wireless communication transceiver, communication between the apparatus and the host device.

Example 86 includes the apparatus of Examples 85, and further includes means for establishing a communication session with the host device via the wireless communication transceiver.

Example 87 includes the apparatus of Examples 86, where the communication session is associated with a personal area network including: a peer-to-peer link between the apparatus and the host device; and a wireless fidelity (WiFi) link between the apparatus and the host device via a network node.

Example 88 includes the apparatus of any one of Examples 70-87, and further includes means for receiving, via a microphone, microphone audio data based on an audio input received by the microphone.

Example 89 includes the apparatus of any one of Examples 70-88, and further includes means for receiving audio output data; and means for providing the audio output data to a speaker.

Example 90 includes the apparatus of any one of Examples 70-89, where the apparatus is a wearable electronic device, an earbud, a hearing aid device, a mixed reality or augmented reality glasses device, a headset, a virtual reality headset, a mixed reality headset, or an augmented reality headset.

Example 91 includes the apparatus of any one of Examples 70-90, where the host device includes a modem configured to send processed microphone audio data generated based on the one or more audio processing operations performed on the microphone audio data.

Example 92 includes the apparatus of any one of Examples 70-91, where the host device is a mobile phone, a desktop computer, a tablet computer device, a voice-controlled speaker system, or a vehicle.

According to Example 93, a device includes a memory configured to store audio processing configuration data that indicates one or more audio processing configurations; and one or more processors coupled to the memory, the one or more processors configured to receive, from an audio device, an indicator that indicates an audio processing configuration of the one or more audio processing configurations, the audio processing configuration associated with one or more audio processing operations; based on the indicator, configure the one or more processors to perform the one or more audio processing operations; receive, from the audio device, microphone audio data; and perform, based on the microphone audio data, the one or more audio processing operations to generate an audio output.

Example 94 includes the device of Example 93, where the one or more audio processing operations include echo cancellation noise suppression (ECNS) processing operations, pre-processing operations, post-processing operations, or a combination thereof.

Example 95 includes the device of Example 93 or Example 94, where the one or more processors include an embedded neuron processing unit (ENPU) configured to perform the one or more audio processing operations.

Example 96 includes the device of any of Examples 93-95, where: the one or more processors are configured to obtain a power indicator, and the power indicator indicates a power level of a battery of the device, a charging status of the battery of the device, or a combination thereof.

Example 97 includes the device of Example 96, where the one or more processors are configured to: perform a comparison based on the power indicator and one or more thresholds; generate a second indicator based on a result of the comparison, where the second indicator indicates for the audio device to perform the one or more audio processing operations; send the second indicator to the audio device; and configure the one or more processors to selectively bypass the one or more audio processing operations.

Example 98 includes the device of Example 97, where, to selectively bypass the one or more audio processing operations, the one or more processors are configured to deactivate a noise reducer, a pre-processing unit, a post-processing unit, or a combination thereof.

Example 99 includes the device of Example 96, where: the one or more processors are configured to send, to the audio device, the power indicator; and the power indicator is sent prior to receipt of the indicator.

Example 100 includes the device of Example 96, further including: a battery; and a sensor coupled to the battery and configured to generate the power indicator based on a state associated with the battery.

Example 101 includes the device of any of Examples 93-100, where: the one or more processors are configured to receive, from the audio device, another indicator to offload an echo cancellation (EC) operation, a noise suppression operation, a pre-processing operation, and a post-processing operation.

Example 102 includes the device of any of Examples 101, where the other indicator is sent by the audio device in response to an input received by the audio device; and the input indicates to offload, from the audio device, the EC operation, the noise suppression operation, the pre-processing operation, and the post-processing operation.

Example 103 includes the device of any of Examples 93-102, further including: a wireless communication transceiver configured to enable communication between the device and the audio device; and where the one or more processors are configured to establish a communication session with the host device via the wireless communication transceiver.

Example 104 includes the device of Example 103, where the communication session is associated with a personal area network including: a peer-to-peer link between the device and the host device; and a wireless fidelity (WiFi) link between the device and the host device via a network node.

Example 105 includes the device of any of Examples 93-104, where the device includes a modem configured to send audio output generated based on the one or more audio processing operations performed on the microphone audio data.

Example 106 includes the device of any of Examples 93-105, where the device is a mobile phone, a desktop computer, a tablet computer device, a voice-controlled speaker system, or a vehicle.

Example 107 includes the device of any of Examples 93-106, where the audio device is a wearable electronic device, an earbud, a hearing aid device, a mixed reality or augmented reality glasses device, a headset, a virtual reality headset, a mixed reality headset, or an augmented reality headset.

According to Example 108, a method includes receiving, from an audio device, an indicator that indicates an audio processing configuration of one or more audio processing configurations, the audio processing configuration associated with one or more audio processing operations; based on the indicator, configuring one or more processors to perform the one or more audio processing operations; receiving, from the audio device, microphone audio data; and performing, based on the microphone audio data, the one or more audio processing operations to generate an audio output.

Example 109 includes the method of Example 108, where the one or more audio processing operations include echo cancellation noise suppression (ECNS) processing operations, pre-processing operations, post-processing operations, or a combination thereof.

Example 110 includes the method of Example 108 or Example 109, where the one or more processors include an embedded neuron processing unit (ENPU) configured to perform the one or more audio processing operations.

Example 111 includes the method of any of Examples 108-110, and further includes obtaining a power indicator, and the power indicator indicates a power level of a battery of a device that includes the one or more processors, a charging status of the battery of the device, or a combination thereof.

Example 112 includes the method of Example 111, and further includes: performing a comparison based on the power indicator and one or more thresholds; generating a second indicator based on a result of the comparison, where the second indicator indicates for the audio device to perform the one or more audio processing operations; sending the second indicator to the audio device; and configuring the one or more processors to selectively bypass the one or more audio processing operations.

Example 113 includes the method of Example 112, to selectively bypass the one or more audio processing operations, the method further includes deactivating a noise reducer, a pre-processing unit, a post-processing unit, or a combination thereof.

Example 114 includes the method of Example 111, and further includes sending, to the audio device, the power indicator; and where the power indicator is sent prior to receipt of the indicator.

Example 115 includes the method of Example 111, and further includes generating the power indicator based on a state associated with the battery.

Example 116 includes the method of any of Examples 108-100, and further includes receiving, from the audio device, another indicator to offload an echo cancellation (EC) operation, a noise suppression operation, a pre-processing operation, and a post-processing operation.

Example 117 includes the method of Example 116, where the other indicator is sent by the audio device in response to an input received by the audio device, the input indicates to offload, from the audio device, the EC operation, the noise suppression operation, the pre-processing operation, and the post-processing operation.

Example 118 includes the method of any of Examples 108-117, and further includes establishing a communication session between the audio device and a device that includes the one or more processors.

Example 119 includes the method of Example 118, where the communication session is associated with a personal area network including: a peer-to-peer link between the device and the audio device; and a wireless fidelity (WiFi) link between the device and the audio device via a network node.

Example 120 includes the method of any of Examples 108-119, and further includes sending, via a modem, audio output generated based on the one or more audio processing operations performed on the microphone audio data.

Example 121 includes the method of any of Examples 108-120, where the one or more processors are included in a mobile phone, a desktop computer, a tablet computer device, a voice-controlled speaker system, or a vehicle.

Example 122 includes the method of any of Examples 108-121, where the audio device is a wearable electronic device, an earbud, a hearing aid device, a mixed reality or augmented reality glasses device, a headset, a virtual reality headset, a mixed reality headset, or an augmented reality headset.

According to Example 123, a non-transitory computer-readable medium storing instructions that are executable by one or more processors to cause the one or more processors to receive, from an audio device, an indicator that indicates an audio processing configuration of one or more audio processing configurations, the audio processing configuration associated with one or more audio processing operations; based on the indicator, configure the one or more processors to perform the one or more audio processing operations; receive, from the audio device, microphone audio data; and perform, based on the microphone audio data, the one or more audio processing operations to generate an audio output.

Example 124 includes the non-transitory computer-readable medium of Example 123, where the one or more audio processing operations include echo cancellation noise suppression (ECNS) processing operations, pre-processing operations, post-processing operations, or a combination thereof.

Example 125 includes the non-transitory computer-readable medium of Example 123 or Example 124, where the one or more processors include an embedded neuron processing unit (ENPU) configured to perform the one or more audio processing operations.

Example 126 includes the non-transitory computer-readable medium of any of Examples 123-125, where the instructions are executable by the one or more processors to cause the one or more processors to obtain a power indicator, and the power indicator indicates a power level of a battery of a device that includes the non-transitory computer-readable medium, a charging status of the battery of the device, or a combination thereof.

Example 127 includes the non-transitory computer-readable medium of Example 126, where the instructions are executable by the one or more processors to cause the one or more processors to: perform a comparison based on the power indicator and one or more thresholds; generate a second indicator based on a result of the comparison, where the second indicator indicates for the audio device to perform the one or more audio processing operations; send the second indicator to the audio device; and configure the one or more processors to selectively bypass the one or more audio processing operations.

Example 128 includes the non-transitory computer-readable medium of Example 127, where, to selectively bypass the one or more audio processing operations, where the instructions are executable by the one or more processors to cause the one or more processors to deactivate a noise reducer, a pre-processing unit, a post-processing unit, or a combination thereof.

Example 129 includes the non-transitory computer-readable medium of Example 126, where: where the instructions are executable by the one or more processors to cause the one or more processors to send, to the audio device, the power indicator; and the power indicator is sent prior to receipt of the indicator.

Example 130 includes the non-transitory computer-readable medium of Example 126, where the instructions are executable by the one or more processors to cause the one or more processors to generate the power indicator based on a state associated with the battery.

Example 131 includes the non-transitory computer-readable medium of any of Examples 123-130, where the instructions are executable by the one or more processors to cause the one or more processors to receive, from the audio device, another indicator to offload an echo cancellation (EC) operation, a noise suppression operation, a pre-processing operation, and a post-processing operation.

Example 132 includes the non-transitory computer-readable medium of Example 131, where the other indicator is sent by the audio device in response to an input received by the audio device, the input indicates to offload, from the audio device, the EC operation, the noise suppression operation, the pre-processing operation, and the post-processing operation.

Example 133 includes the non-transitory computer-readable medium of any of Examples 123-132, where the instructions are executable by the one or more processors to cause the one or more processors to establish a communication session between the audio device and a device that includes the one or more processors.

Example 134 includes the non-transitory computer-readable medium of Example 133, where the communication session is associated with a personal area network including: a peer-to-peer link between the device and the host device; and a wireless fidelity (WiFi) link between the device and the host device via a network node.

Example 135 includes the non-transitory computer-readable medium of any of Examples 123-134, where the instructions are executable by the one or more processors to cause the one or more processors to send, via a modem, audio output generated based on the one or more audio processing operations performed on the microphone audio data.

Example 136 includes the non-transitory computer-readable medium of any of Examples 123-135, where the non-transitory computer-readable medium is included in a mobile phone, a desktop computer, a tablet computer device, a voice-controlled speaker system, or a vehicle.

Example 137 includes the non-transitory computer-readable medium of any of Examples 123-136, where the audio device is a wearable electronic device, an earbud, a hearing aid device, a mixed reality or augmented reality glasses device, a headset, a virtual reality headset, a mixed reality headset, or an augmented reality headset.

According to Example 138, an apparatus includes means for receiving, from an audio device, an indicator that indicates an audio processing configuration of one or more audio processing configurations, the audio processing configuration associated with one or more audio processing operations; means for configuring, based on the indicator, the apparatus to perform the one or more audio processing operations; means for receiving, from the audio device, microphone audio data; and means for performing, based on the microphone audio data, the one or more audio processing operations to generate an audio output.

Example 139 includes the apparatus of Example 138, where the one or more audio processing operations include echo cancellation noise suppression (ECNS) processing operations, pre-processing operations, post-processing operations, or a combination thereof.

Example 140 includes the apparatus of Example 138 or Example 139, where the one or more processors include an embedded neuron processing unit (ENPU) configured to perform the one or more audio processing operations.

Example 141 includes the apparatus of any of Examples 138-140, and further includes means for obtaining a power indicator, and the power indicator indicates a power level of a battery of the apparatus, a charging status of the battery of the apparatus, or a combination thereof.

Example 142 includes the apparatus of Examples 141, and further includes: means for performing a comparison based on the power indicator and one or more thresholds; means for generating a second indicator based on a result of the comparison, where the second indicator indicates for the audio device to perform the one or more audio processing operations; means for sending the second indicator to the audio device; and means for configuring the one or more processors to selectively bypass the one or more audio processing operations.

Example 143 includes the apparatus of Example 142, and further includes means for deactivating a noise reducer, a pre-processing unit, a post-processing unit, or a combination thereof.

Example 144 includes the apparatus of Example 141, and further includes means for sending, to the audio device, the power indicator; and where the power indicator is sent prior to receipt of the indicator.

Example 145 includes the apparatus of Example 141, and further includes means for generating the power indicator based on a state associated with the battery.

Example 146 includes the apparatus of any of Examples 138-145, and further includes means for receiving, from the audio device, another indicator to offload an echo cancellation (EC) operation, a noise suppression operation, a pre-processing operation, and a post-processing operation.

Example 147 includes the apparatus of Example 146, where the other indicator is sent by the audio device in response to an input received by the audio device, the input indicates to offload, from the audio device, the EC operation, the noise suppression operation, the pre-processing operation, and the post-processing operation.

Example 148 includes the apparatus of any of Examples 138-117, and further includes means for establishing a communication session between the audio device and the apparatus.

Example 149 includes the apparatus of Example 148, where the communication session is associated with a personal area network including: a peer-to-peer link between the apparatus and the audio device; and a wireless fidelity (WiFi) link between the apparatus and the audio device via a network node.

Example 150 includes the apparatus of any of Examples 138-149, and further includes means for sending, via a modem, audio output generated based on the one or more audio processing operations performed on the microphone audio data.

Example 151 includes the apparatus of any of Examples 138-150, where the apparatus includes a mobile phone, a desktop computer, a tablet computer device, a voice-controlled speaker system, or a vehicle.

Example 152 includes the apparatus of any of Examples 138-151, where the audio device is a wearable electronic device, an earbud, a hearing aid device, a mixed reality or augmented reality glasses device, a headset, a virtual reality headset, a mixed reality headset, or an augmented reality headset.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store processing configuration data that indicates one or more processing configurations; and
one or more processors coupled to the memory, the one or more processors configured to:
select, based on a power indicator, a processing configuration of the one or more processing configurations; and
based on the selected processing configuration:
send an indicator to a host device to offload one or more audio processing operations;
configure the one or more processors to selectively bypass the one or more audio processing operations; and
send, to the host device, microphone audio data based on an audio input received by a microphone.

2. The device of claim 1, wherein:
the one or more processors are configured to obtain the power indicator, and
the power indicator indicates a power level of a battery of the device, a charging status of the battery of the device, or a combination thereof.

3. The device of claim 1, wherein the one or more processors are configured to receive an input that indicates, for the processing configuration, a threshold power level, the one or more audio processing operations, or a combination thereof.

4. The device of claim 1, wherein the one or more processors are configured to:
perform a comparison based on the power indicator and one or more thresholds, and
wherein the processing configuration is selected based on a result of the comparison.

5. The device of claim 4, wherein:
the power indicator indicates a power level;
based on the power level being less than or equal to a first threshold of the one or more thresholds, the one or more audio processing operations that are selected to bypass include echo cancellation noise suppression (ECNS) processing operations; and
the indicator indicates to offload the ECNS processing operations of the one or more audio processing operations to an embedded neuron processing unit (ENPU) of the host device.

6. The device of claim 5, wherein, based on the power level being less than or equal to the first threshold of the one or more thresholds, the one or more audio processing operations that are selected to bypass include:
the ECNS processing operations, and
pre-processing operations, post-processing operations, or a combination thereof.

7. The device of claim 6, wherein, after the one or more audio processing operations are offloaded to the host device, the one or more processors are configured to:
receive, from the host device, a second indicator to perform the one or more audio processing operations;
configure the one or more processors to perform the one or more audio processing operations;
perform the one or more audio processing operations on the audio input to generate processed microphone audio data; and
send the processed microphone audio data to the host device.

8. The device of claim 1, wherein the one or more processors are configured to:
receive an input that indicates to offload, to the host device, an echo cancellation (EC) operation, a noise suppression operation, a pre-processing operation, and a post-processing operation; and
in response to the input, send another indicator to the host device to offload the EC operation, the noise suppression operation, the pre-processing operation, and the post-processing operation.

9. The device of claim 1, wherein:
the one or more processors are configured to receive, from the host device, a host power indicator that indicates a power level of a battery of the host device, a charging status of the battery of the host device, or a combination thereof;
the processing configuration is further selected based on the host power indicator; and
the one or more audio processing operations include echo cancellation noise suppression (ECNS) operations, a noise suppression operation, a pre-processing operation, a post-processing operation, or a combination thereof.

10. The device of claim 1, wherein, to selectively bypass the one or more audio processing operations, the one or more processors are configured to deactivate a noise reducer, a pre-processing unit, a post-processing unit, or a combination thereof.

11. The device of claim 1, further comprising:
a battery; and
a sensor coupled to the battery and configured to generate the power indicator based on a state associated with the battery.

12. The device of claim 1, further comprising a wireless communication transceiver configured to enable communication between the device and the host device.

13. The device of claim 12, wherein:
the one or more processors are configured to establish a communication session with the host device via the wireless communication transceiver; and
the communication session is associated with a personal area network including:
a peer-to-peer link between the device and the host device; and
a wireless fidelity (WiFi) link between the device and the host device via a network node.

14. The device of claim 1, further comprising the microphone configured to receive the audio input and generate the microphone audio data based on the audio input.

15. The device of claim 1, further comprising:
a speaker configured to output audio based on audio output data, and
wherein the one or more processors are configured to receive the audio output data and provide the audio output data to the speaker.

16. The device of claim 1, wherein the device is a wearable electronic device, an earbud, a hearing aid device, a mixed reality or augmented reality glasses device, a headset, a virtual reality headset, a mixed reality headset, or an augmented reality headset.

17. The device of claim 1, wherein the host device includes a modem configured to send processed microphone audio data generated based on the one or more audio processing operations performed on the microphone audio data.

18. The device of claim 1, wherein the host device is a mobile phone, a desktop computer, a tablet computer device, a voice-controlled speaker system, or a vehicle.

19. A method of operating a processor of an audio device, the method comprising:
selecting, based on a power indicator, a processing configuration of one or more processing configurations; and
based on the selected processing configuration:
sending an indicator to a host device to offload one or more audio processing operations;
configuring the one or more processors to selectively bypass the one or more audio processing operations; and
sending, to the host device, microphone audio data based on an audio input received by a microphone.

20. A non-transitory computer-readable medium storing instructions that are executable by one or more processors to cause the one or more processors to:
select, based on a power indicator, a processing configuration of one or more processing configurations; and
based on the selected processing configuration:
send an indicator to a host device to offload one or more audio processing operations;
configure the one or more processors to selectively bypass the one or more audio processing operations; and
send, to the host device, microphone audio data based on an audio input received by a microphone.
